(19) United States
(12) Patent Application Publication
(10) Pub. No.: US 2026/0255271 A1
(43) Pub. Date: Aug. 27, 2026

(54) POWER SAVING WITH ON-DEVICE LEARNING

(71) Applicant: Samsung Electronics Co., Ltd., Suwon-si (KR)

(72) Inventors: Anum Ali, Frisco, TX (US); Vutha Va, Plano, TX (US); Yuqiang Heng, Plano, TX (US); Boon Loong Ng, Plano, TX (US)

(21) Appl. No.: 19/535,776

(22) Filed: Feb. 10, 2026

Related U.S. Application Data
(60) Provisional application No. 63/761,377, filed on Feb. 21, 2025.

(51) Int. Cl. H04W 52/02; H04W 76/27

(52) U.S. Cl. CPC H04W 52/0235; H04W 76/27

(57) ABSTRACT

A method includes determining, by a first electronic device, whether at least one power saving mode is identified for application based on a detection of a trigger event using an on-device learning component of the first electronic device, the on-device learning component configured to select a power saving mode based on information associated with the trigger event. The method further includes, in response to determining that the at least one power saving mode is identified, applying, by the first electronic device, the identified at least one power saving mode for the trigger event. The method additionally includes monitoring, by the first electronic device, for degradation associated with the applied at least one power saving mode during the trigger event.

### CROSS-REFERENCE TO RELATED APPLICATION AND CLAIM OF PRIORITY

The present application claims priority under 35 U.S.C. § 119 (e) to U.S. Provisional Patent Application No. 63/761,377 filed on Feb. 21, 2025, which is hereby incorporated by reference in its entirety.

### TECHNICAL FIELD

This disclosure relates generally to wireless networks. More specifically, this disclosure relates to a method and apparatus for power saving with on-device learning in wireless communications.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for power saving with on-device learning in wireless communication systems.

In one embodiment, a method includes determining, by a first electronic device, whether at least one power saving mode is identified for application based on a detection of a trigger event using an on-device learning component of the first electronic device, the on-device learning component configured to select a power saving mode based on information associated with the trigger event. The method further includes, in response to determining that the at least one power saving mode is identified, applying, by the first electronic device, the identified at least one power saving mode for the trigger event. The method additionally includes monitoring, by the first electronic device, for degradation associated with the applied at least one power saving mode during the trigger event.

In another embodiment, a first electronic device is provided. The first electronic device includes a memory and a processor operably coupled to the memory. The processor is configured to determine whether at least one power saving mode is identified for application based on a detection of a trigger event using an on-device learning component of the first electronic device, the on-device learning component configured to select a power saving mode based on information associated with the trigger event. The processor is further configured to, in response to a determination that the at least one power saving mode is identified, apply the identified at least one power saving mode for the trigger event. In addition, the processor is further configured to monitor for degradation associated with the applied at least one power saving mode during the trigger event.

In yet another embodiment, a non-transitory computer readable medium embodying a computer program is provided. The computer program includes program code that, when executed by a processor of a first electronic device, causes the first electronic device to: determine whether at least one power saving mode is identified for application based on a detection of a trigger event using an on-device learning component of the first electronic device, the on-device learning component configured to select a power saving mode based on information associated with the trigger event; in response to a determination that the at least one power saving mode is identified, apply the identified at least one power saving mode for the trigger event; and to monitor for degradation associated with the applied at least one power saving mode during the trigger event.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network in accordance with example embodiments of the present disclosure;

FIG. 2 illustrates an example gNB in accordance with example embodiments of the present disclosure;

FIG. 3 illustrates an example UE in accordance with example embodiments of the present disclosure;

FIG. 4 illustrates an example diagram for UAI framework introduced in 3GPP Release 16;

FIG. 5 illustrates an example pipeline for an on-device learning-based power saving method in accordance with example embodiments of the present disclosure;

FIG. 6 illustrates an example process of selecting an early RRC release mode in accordance with example embodiments of the present disclosure;

FIG. 7 illustrates an example process of selecting an early RRC release mode in accordance with the example embodiments of the present disclosure;

FIG. 8 illustrates an example process of selecting an early RRC release mode in accordance with example embodiments of the present disclosure;

FIG. 9 illustrates an example process of calculating an expected total power in accordance with example embodiments of the present disclosure;

FIG. 10 illustrates an example process for monitoring for degradation in accordance with example embodiments of the present disclosure;

FIG. 11 illustrates an example process of activating a timer adaptation in accordance with example embodiments of the present disclosure;

FIG. 12 illustrates an example process of collecting throughput statistics for MIMO/BW optimization in accordance with example embodiments of the present disclosure;

FIG. 13 illustrates an example process for selecting a MIMO/BW mode in accordance with example embodiments of the present disclosure;

FIG. 14 illustrates an example process of detecting degradation for a MIMO/BW mode in accordance with example embodiments of the present disclosure;

FIG. 15 illustrates an example process of collecting statistics for a DVFS mode in accordance with example embodiments of the present disclosure;

FIG. 16 illustrates an example process of detecting a degradation during a DVFS mode in accordance with example embodiments of the present disclosure;

FIG. 17 illustrates an example process of grouping and ungrouping of an application according to embodiments of the present disclosure;

FIG. 18 illustrates an example process of multi-application degradation and statistics recollection in accordance with example embodiments of the present disclosure;

FIG. 19 illustrates an example process of multi-solution approach in accordance with example embodiments of the present disclosure; and

FIG. 20 illustrates a flow chart of the on-device learning based power saving method in accordance with example embodiments of the present disclosure.

### DETAILED DESCRIPTION

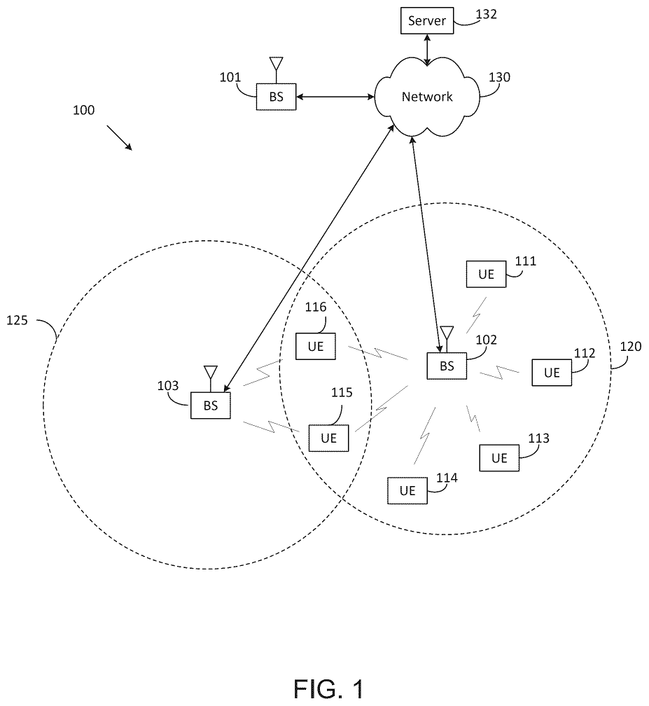

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of on-device learning techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support AI-based channel estimation in wireless communication systems. In certain embodiments, one or more of the gNBs 101-103 include circuitry, programing, or a combination thereof, to perform power savings with on-device learning in cellular systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

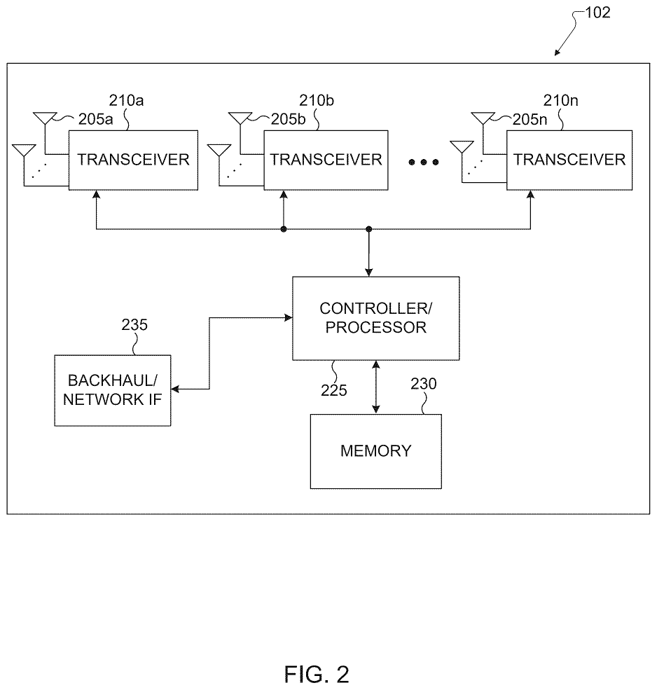

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform power savings with on-device learning in wireless communication systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

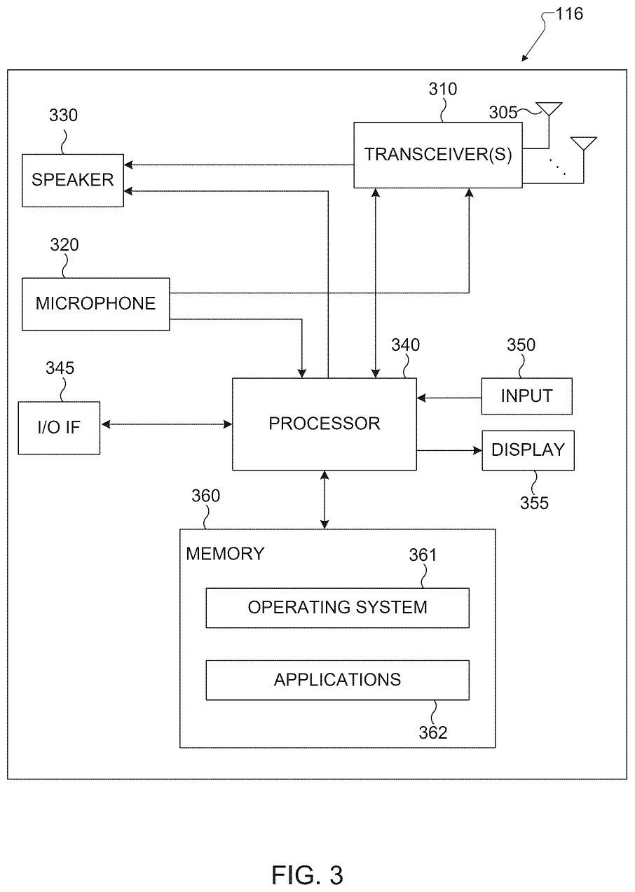

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support perform power savings with on-device learning in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The modern cellular systems, such as those described regarding FIGS. 1-3, have had a transforming impact on everyday life of billions of users across the globe. While earlier generations of the cellular communication enabled widespread use of handheld mobile devices, upcoming generations target futuristic use cases enabled by faster speeds, lower latency, and greater capacity, e.g., augment reality (AR), self-driving cars, and advanced industrial automation. The deployment of the 5G is relatively mature in some parts of the world, whereas it is currently being deployed in some other parts of the world. In parallel, the development of the sixth generation (6G) is gaining the momentum.

Cellular mobile devices may be powered by a battery and have a limited capacity. As such, a considerable focus has been made on the power efficiency of the 5G and 6G systems. Specifically, several 5G UE power-saving techniques are investigated and standardized. These techniques may include cross-slot scheduling, bandwidth part (BWP) adaptation, discontinuous reception (DRX), radio resource control (RRC)-inactive mode, wakeup signal (WUS), two-step RACH, UE assistance information (UAI), etc. In addition, the device vendors may explore various ways to save power, e.g., by the use of dynamic voltage and frequency scaling (DVFS).

One power saving approach may utilize low power RRC states by placing a device (e.g., the UE) to a lower power consumption state after a period of inactivity. Specifically, when the device is actively transmitting and/or receiving the data, it is in the RRC_CONNECTED state. If the device does not transmit and/or receive for a time period, the network (NW) may instruct the device to enter into a lower power state. In 5G, there may be two such possible states: RRC_INACTIVE and RRC_IDLE. The difference between the INACTIVE state and the IDLE state may lie in the information retained at the UE, a NW related to the connection, and the level of signaling utilized to transition back to the RRC_CONNECTED state. Transitioning from the RRC_INACTIVE state may utilize less signaling, and hence may be quicker as compared to transitioning from the RRC_IDLE state. The NW may maintain a data inactivity timer called an RRC tail timer. When there is no data exchange between the UE and the NW for the RRC tail time, the NW may release the RRC connection and place the device in a lower power state.

Another approach may include bandwidth adaptation. The 5G supports several hundreds of MHz of bandwidth to provide a high throughput. Operations with such bandwidths may utilize large Fourier transforms and a high-performance analog-to-digital converter (ADC). Since the UE may not use a high throughput at all times, the concept of bandwidth part (BWP) may be introduced in 5G NR. BWP refers to a portion of the system BW, over which the UE is configured to transmit and receive signals. The UE can be configured with up to 4 uplink (UL) and downlink (DL) BWPs, but only one BWP may be active at any given time. The NW may control which BWP the UE may operate on. The NW can switch the active BWP of the UE among the configured BWPs via downlink control information (DCI).

Another approach may include maximum MIMO layers adaptation. A large number of antennas at the UE may enable high throughput applications, but incur a high power consumption. Hence, through the antenna adaptation, the UE may save power when a high throughput is not being used. While using fewer antennas, the power savings may come from turning off the RF components as well as skipping the channel estimation for the unused antennas. The maximum number of MIMO layers can be adapted under the BWP framework. Specifically, multiple BWPs can be configured, each with a different maximum number of MIMO layers. This adaption may be also controlled by the NW.

Another approach may include utilizing a DVFS mechanism. DVFS is a power saving technique that adjusts the voltage and frequency of an integrated circuit (IC) according to the workload. The technique exploits the fact that an IC has discrete frequency and voltage settings, and uses the voltage and frequency pair that can satisfy the current workload, but is not an over configuration of the IC. The power consumption of the IC may scale linearly with the frequency and quadratically with the voltage. In cellular chipsets, the DVFS may be set based on the NW configured parameters, e.g., BW and MIMO that may dictate the highest possible workload. Since the NW configured parameters are semi-static, the setting for DVFS may be also expected to be semi-static.

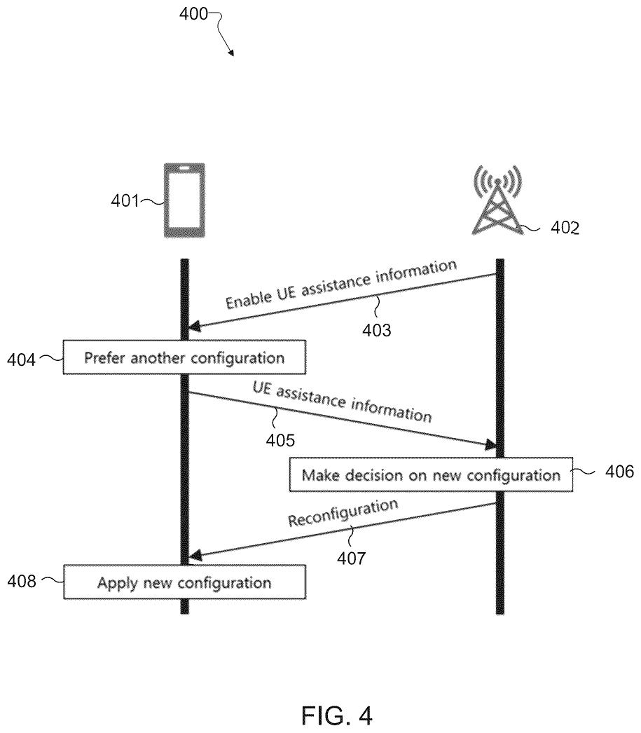

Another approach may include a UE assistance framework. Through the UAI introduced in 3GPP Release 16, the UE can influence its own configuration by informing the NW about its preferences. The UAI messages can indicate preferred parameters for saving power, reducing overheating, and indicating a preferred RRC state among others. The UE assistance framework is discussed further in detail with reference to FIG. 4.

The settings that influence the UE power saving may be semi-static, and examples of these settings may be as following:
For the RRC tail time, the NW may use a fixed value for all applications using data, e.g., 10 seconds.
The NW may configure the same number of maximum layers to the users depending on the UE capability, e.g., all UEs indicating capability to support 4 layers may be configured to use 4 maximum layers.
The NW may configure the same BW to all of the UEs on the NW, e.g., 100 MHz for users on n41 band.
The device may use the same DVFS setting for a given NW configuration, e.g., the same DVFS for a given MIMO and BW configuration.

Though these choices may change over different coverage areas depending on the implementation, generally these settings are relatively static. There can be different motivations behind this. For example, a fixed tail timer may be used to provide a reasonable performance in a wide variety of applications and simplify the NW implementation. The maximum number of MIMO layers and BW may be configured, and subsequently the actual used layers and allocated physical resource blocks (PRBs) may be decided based on user's channel and throughput requests. Nevertheless, the semi-static and generic nature of these choices may imply that these choices may not be optimal in all of the scenarios. For sporadic traffic, a long RRC tail timer may imply that the UE stays in the RRC connected state unnecessarily even though it is unlikely to consume data. A large number of MIMO layers and BW may imply an overhead in monitoring reference signals, estimating channel conditions, and reporting to the NW, which may not be necessary if the application being used does not utilize a very high throughput.

This disclosure provides approaches for power saving using on-device learning in cellular communications. Using on-device learning, the performance of the UE can be optimized. Various statistics that are low cost to learn and maintain can be utilized. Learning at the UE may also avoid potential privacy concerns that may arise with data sharing. In addition, learning at the UE may provide an opportunity for hyper-personalization where everything may be near-optimal and resources may be used in the most efficient way for the optimal UE performance.

By enabling on-device learning-based power saving, the present disclosure allows the UE to select the optimal power saving mode based on its relevant traffic statistics. By allowing the power saving mode to be modified in response to a trigger event, the present disclosure helps mitigate performance degradation when statistics during data collection differ from statistics during power saving. By allowing dynamic regrouping of a particular application based on current application statistics, the present disclosure enhances overall memory and power efficiency.

FIGS. 4-20 illustrate non-limiting embodiments of the on-device learning-based power saving approaches, the resultant benefits, and related concepts thereof in greater detail in accordance with the present disclosure.

FIG. 4 illustrates an example diagram for UAI framework 400 introduced in 3GPP Release 16.

As shown in FIG. 4, the UAI framework 400 starts at operation 403. At operation 403, the NW (e.g., a gNB 101-103 of FIG. 2) 402 may enable the UE 401 to use the UAI framework. At operation 404, the UE 401 may determine its preference for configuration. At operation 405, if the UE 401 prefers a configuration other than the one it is currently configured with, the UE 401 may transmit a UAI message to the gNB 402. The UAI messages may indicate preferred parameters for saving power, reducing overheating, and indicating preferred RRC state among others. At operation 406, the gNB 402 may decide whether a new configuration should be utilized for the UE 401. At operation 407, the gNB 402 may transmit new or reconfiguration information to the UE 401. At operation 408, the UE 401 may in turn apply the new configuration.

Thus, the UAI framework 400 may allow the UE 401 to influence its own configuration by informing the NW 402 its preferences for configuration.

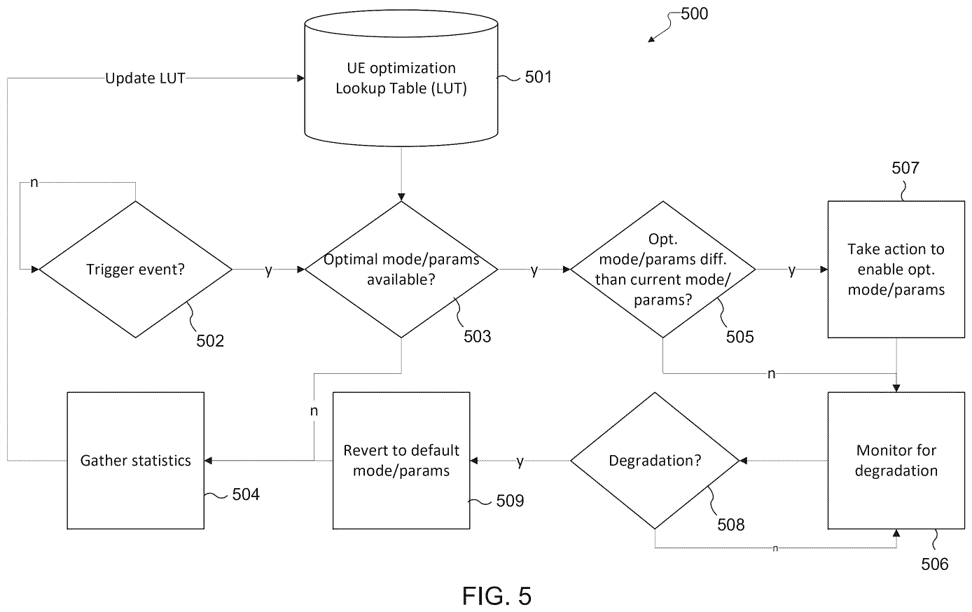

FIG. 5 illustrates an example pipeline for an on-device learning-based power saving method 500 in accordance with example embodiments of the present disclosure. The example pipeline as shown in FIG. 5 is for illustration only, and could have the same or similar configuration. One or more of the components illustrated in FIG. 5 may be implemented in specialized circuitry configured to perform the noted functions or one or more of the components may be implemented by one or more processors executing instructions to perform the noted functions. Other embodiments of the on-device learning-based power saving method in accordance with the present disclosure could be used without departing from the scope of this disclosure. FIG. 5 does not limit the scope of this disclosure to any particular embodiment of the on-device learning-based power saving methods.

As shown in FIG. 5, the method 500 may begin at step 502. At 502, the device (e.g., the UE) determines if a trigger event has occurred. The trigger event may include at least one of: (1) opening of an application, (2) opening of any application from a group of applications, or (3) starting of a service after an application is already opened etc. Regarding (1), the UE may not identify the application, e.g., Netflix® or WhatsApp®, etc. Instead, the UE may only distinguish different applications, e.g., application “A” to “B”. Distinguishing applications on the mobile device may be easily performed based on the application identification (ID). Identifying any given application, however, may be challenging since this may utilize development and maintenance of a look up table (LUT) that maps application IDs to the applications. This may be challenging simply due to the enormous number of possible applications and continuous development of new applications.

Regarding (2), the motivation of grouping multiple applications together and collecting statistics for those may be to reduce the memory requests at the device. Since some statistical information and optimal parameters are to be stored at the device, it can be beneficial to group multiple applications together. Such grouping can itself be made based on initial statistics collection and correlation of those statistics among multiple applications. Regarding (3), the trigger event may include starting of a service within an application targeting cases where one application provides multiple services. For example, WhatsApp® is a messaging service as well as a voice and video call application.

The opening of an application can be detected, and subsequently the service may be detected using other available means, e.g., application accessing and utilizing the microphone and/or video camera, etc. Alternatively, a traffic classifier that classifies the traffic into multiple types may be used to obtain the specific type of service within an application.

Another consideration for defining the trigger event may be the channel state. The channel state can be defined in terms of signal quality metrics, e.g., reference signal received power (RSRP), reference signal received quality (RSRQ), and signal to interference plus noise ratio (SINR). An example channel state in terms of RSRP could be “bad” (e.g., RSRP<−110 dBm), “medium” (e.g., −110 dBm<RSRP<−90 dBm) or “good” (e.g., >−90 dBm). Channel state can also be defined in terms of mobility, e.g., low mobility, medium mobility, and high mobility. Mobility metric itself can come from the device speed (possibly utilizing input from GPS, or IMU, etc.), or the variation of the signal quality metrics as a function of time (easily accessible as part of cellular operation). The potential power savings may vary based on the channel state. As such, the trigger event may not only include application or service related information, but also the channel state. More specifically, a trigger event may be opening of an application ID “A” in a channel state “X”. This trigger event may have corresponding optimal mode and/or parameters, but a separate trigger event with the same application ID “A” but in a channel state “Y” may not have corresponding optimal mode and/or parameters that may lead to power saving.

At step 503, the device may determine whether the optimal parameters and/or modes are available for the trigger event. The modes and/or parameters as well as other information, e.g., statistics, may be stored in the UE optimization LUT 501. Statistics may be saved if the statistics update is made on top of the statistics collected so far. Possible modes may include an early RRC release mode (also referred to as the early RRC release solution or the RRC release), MIMO and/or BW mode (also referred to as the MIMO/BW reduction, optimization, configuration, or solution), or DVFS mode (also referred to as the DVFS optimization, configuration, or solution), etc. A parameter for the early RRC release may be the release timer. Parameters for the MIMO/BW configuration may be the number of maximum MIMO layers and/or the maximum BW for the trigger event. Parameters for the DVFS configuration may be the voltage and frequency for the DVFS mode.

At step 504, statistics for subsequent optimization may be collected if it is determined that no optimal mode and/or parameters are available for the trigger event. At step 505, if it is determined that the optimal mode and/or parameters are available, it may be checked whether the determined mode of operation is different from current mode of operation. For example, assume that the DVFS optimization is currently being utilized with parameters that are suitable for the current trigger. There may be a new trigger event. This event may have the early RRC release solution as an optimal mode. The device may turn off the DVFS optimization and turn on the early RRC release solution. It may be also checked whether the determined parameters are different from the current parameters. For example, assume that the early RRC release solution may be currently being used with a fixed timer value of 2 seconds. There may be a new trigger event. This event may have the early RRC release solution with a fixed timer value of 0.5 seconds. In this case, while the optimal mode is the same as the current mode, the parameter of the mode may be changed.

At step 506, if it is determined that the optimal mode and parameter are the same as the one currently being used, no action may be taken and the UE may monitor for degradation. At step 507, if it is determined that the optimal mode and/or parameters are different than the ones currently being used, some action may be taken to enable the optimal mode and parameters. For the early RRC release, this may mean, e.g., using the UAI framework to send a request to the NW to release the RRC connection. Alternatively, if the device has a mechanism to unilaterally release the RRC connection made available to the system designer, such a mechanism may also be used. For MIMO layers, the UE may request the NW to reduce maximum MIMO layers through the UAI framework. If the device has a mechanism to unilaterally reduce the maximum number of layers, e.g., by turning off antennas, such a mechanism may also be used. For BW reduction, maximum BW reduction through the UAI mechanism may be requested. For the DVFS mode, the device may change the voltage and frequency.

At step 508, the device may determine whether a degradation has occurred. If the distributions of the collected statistics and the current statistics differ, a degradation may happen from the determined modes and/or parameters. As an example, consider that the optimal mode is MIMO/BW reduction and some number of layers and BW may be determined from application statistics. A change in application behavior may cause the application to consume more data per unit time than the time when the statistics were calculated. In this case, it may be possible that the selected MIMO/BW may be suboptimal and unable to fulfill the new requests of the application.

At step 509, the system may revert to the default mode and parameters upon detection of a degradation. The default mode may be to disable any optimization mode, and use the parameters that the NW configured for the UE. At this stage, since the previously collected statistics may be no longer optimal, further statistics may be collected, and the UE optimization LUT 501 may be updated. Note that although monitoring for degradation may be continuously performed, a new trigger event may take a precedence and start the process again.

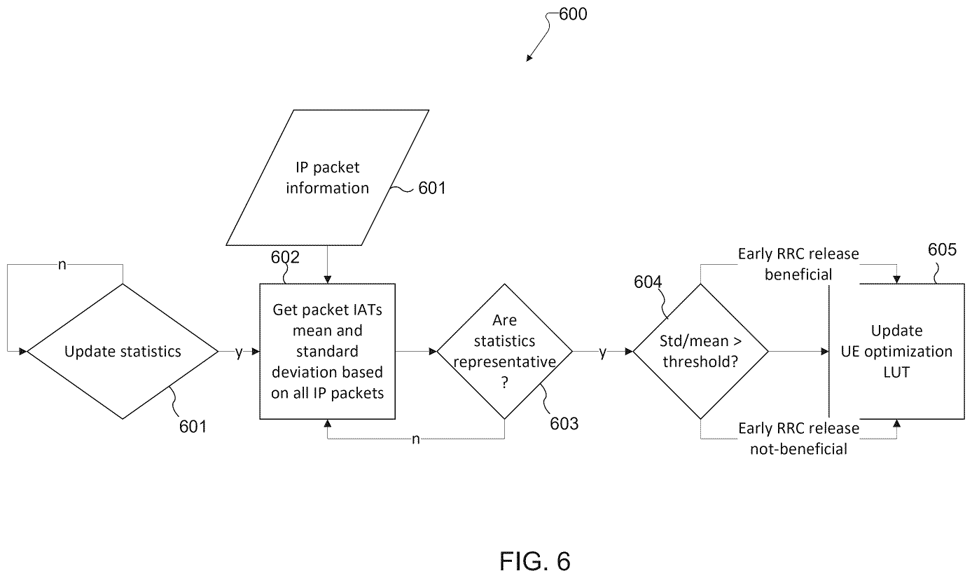

FIG. 6 illustrates an example process 600 of selecting an early RRC release mode in accordance with example embodiments of the present disclosure. The example process as shown in FIG. 6 is for illustration only, and the process could have the same or similar configuration. One or more of the components illustrated in FIG. 6 may be implemented in specialized circuitry configured to perform the noted functions or one or more of the components may be implemented by one or more processors executing instructions to perform the noted functions. Other embodiments of the early RRC release selection process in accordance with the present disclosure could be used without departing from the scope of this disclosure. FIG. 6 does not limit the scope of this disclosure to any particular embodiment of the early RRC release selection processes.

In the example process 600 shown in FIG. 6, the mean and standard deviation of the packet inter-arrival times (IATs) may be used for determining whether the early RRC release solution may be utilized. Since the process 600 is for determining whether the early RRC release solution is to be utilized, the process 600 may be performed only when the statistics are to be updated. The example process 600 may begin at step 601.

At step 601, the device (e.g., the UE) determines whether the statistics are to be updated. The trigger for updating the statistics may be an observation of a degradation. In another embodiment, there may be optional periodic triggering of updating statistics. For example, the statistics may be updated if they have not been updated for a week. The statistics may be updated periodically (i.e., not all the time) since collecting data and processing the collected data for transformation into statistics may present a computational burden.

At step 602, if statistics are to be updated, the device may gather packet IAT statistics based on all internet protocol (IP) packets 601. Gathering statistics for all IP packets may not utilize filtering the packets (hence, simpler), but there may be contamination from packets of other applications, e.g., background applications.

At step 603, the device may determine whether the statistics are representative of the actual properties of the data. This may be performed, e.g., by checking the convergence. As more data are collected, the mean and standard deviation may be calculated incrementally. When the statistics no longer change (based on some tolerance), the statistics may be declared to be representative.

At step 604, the device may compare the ratio of the mean and standard deviation to a threshold to determine if the early RRC release solution may be applied. If the ratio is greater than a threshold, then the early RRC release solution may be beneficial. The rationale may be that if the IATs have a large standard deviation as compared to the mean IAT, then the traffic may be bursty. An example value of the threshold can be 5.

At step 605, the device may update the UE optimization LUT with the information on whether the early RRC release solution may be beneficial or not. Some additional information may also be stored. For example, the ratio of the standard deviation and mean may be stored, so that in the future if the ratio is to be compared to a different threshold, the information may be available and the whole procedure need not be repeated. Also, the standard deviation and the mean themselves may be stored in addition to the number of samples on which this information is calculated. This may allow updating the mean and standard deviation in the future based on new samples rather than calculating the mean and standard deviation from the scratch.

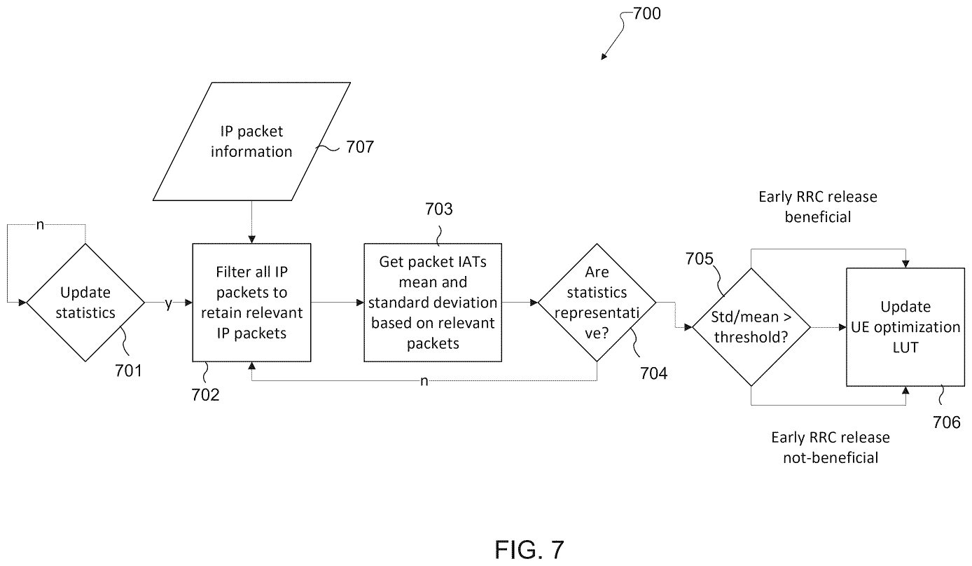

FIG. 7 illustrates an example process 700 of selecting an early RRC release mode in accordance with the example embodiments of the present disclosure. The example process as shown in FIG. 7 is for illustration only, and the process could have the same or similar configuration. One or more of the components illustrated in FIG. 7 may be implemented in specialized circuitry configured to perform the noted functions or one or more of the components may be implemented by one or more processors executing instructions to perform the noted functions. Other embodiments of the early RRC release selection process in accordance with the present disclosure could be used without departing from the scope of this disclosure. FIG. 7 does not limit the scope of this disclosure to any particular embodiment of the early RRC release selection processes.

As shown in FIG. 7, the example process 700 may begin at step 701. At step 701, the device may determine whether the statistics are to be updated. At step 702, if statistics are to be updated, the device may gather IP packet information 707 and the all of the IP packets may be filtered to retain only the relevant IP packets.

At step 703, the mean and standard deviation of only the relevant packets may be obtained for determining whether early RRC release solution may be utilized. Specifically, the statistics may be calculated based on only the relevant packets. The identification of the relevant packets may be based on the application ID. For example, all packets from the application ID of the application in the foreground may be considered as the relevant packets and all other packets may be considered as irrelevant.

At step 704, the device may determine whether statistics are representative of the actual properties of the data. This may be performed, e.g., by checking the convergence. As more data are collected, the mean and standard deviation may be calculated incrementally. When the statistics no longer change (based on a tolerance), the statistics may be declared to be representative.

At step 705, the device may compare the ratio of the mean and standard deviation to a threshold to determine if the early RRC release solution may be applied. If the ratio is greater than a threshold, then the early RRC release solution may be beneficial.

At step 706, the UE optimization LUT may be updated with the information on whether the early RRC release solution may be beneficial or not.

The strength of the determination based on the mean and standard deviation may include the simpleness of the procedure with little processing and memory requests. The weakness may be that the two collected statistics themselves may not provide sufficient information for a near-optimal selection of the early RRC release timer. In absence of more complete statistics, one possibility may be to utilize some reasonable value of the early RRC release timer, e.g., 2 seconds, when the mean and standard deviation exceed a threshold. Another possibility may be to relate the timer to the ratio of the standard deviation to the mean, e.g., a higher ratio indicating a shorter time. Yet another possibility may be to utilize an adaptive timer selection method that considers the most recent traffic from a specific time window, e.g., 30 seconds, and determines a near optimal timer. The adaptive timer selection methods may adapt to variations in the traffic characteristics, but their view may be limited to some timeframe, e.g., 30 seconds in the past. As such, they may not have the complete long term picture of the traffic characteristics.

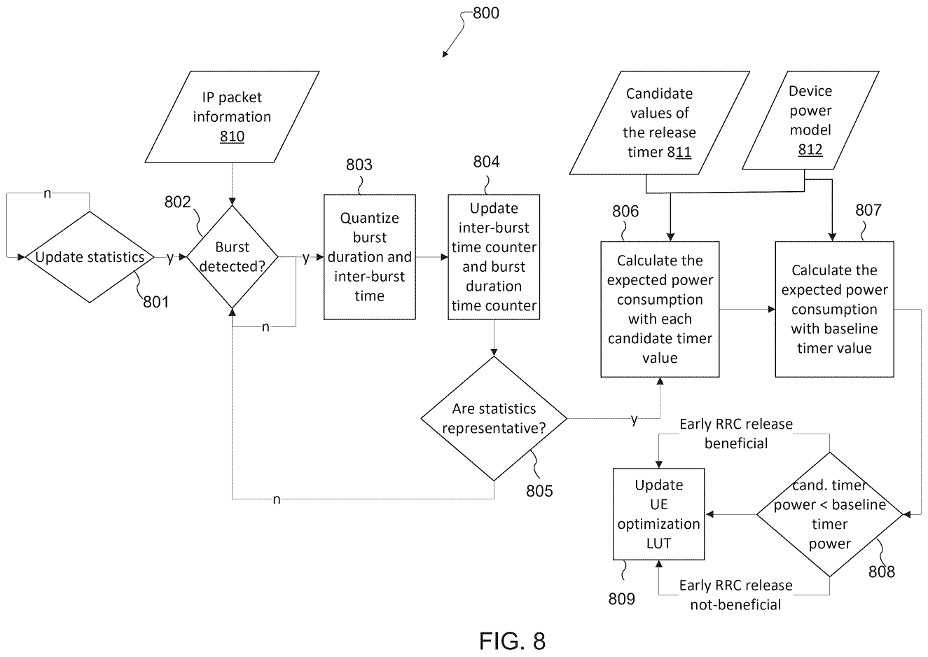

FIG. 8 illustrates an example process 800 of selecting an early RRC release mode in accordance with example embodiments of the present disclosure. The example process as shown in FIG. 8 is for illustration only, and then the process could have the same or similar configuration. One or more of the components illustrated in FIG. 8 may be implemented in specialized circuitry configured to perform the noted functions or one or more of the components may be implemented by one or more processors executing instructions to perform the noted functions. Other embodiments of the process of the early RRC release selection process in accordance with the present disclosure could be used without departing from the scope of this disclosure. FIG. 8 does not limit the scope of this disclosure to any particular embodiment of the early RRC release selection processes.

As shown in FIG. 8, the example process 800 may begin at step 801. At step 801, the device may determine whether the statistics are to be updated. At step 802, the device may determine whether a burst is detected. In this embodiment, the burst duration and inter-burst times may be utilized to determine if early RRC release solution may be used. Specifically, the IP packet information 810 may be used to detect the bursts. Note that in this implementation all IP packets may be used, but filtering can be applied to keep the relevant IP packets as in FIG. 7. The detection of the burst may be based on a threshold on inactivity. For example, after some packets are received and there is no packet received for 0.5 seconds, the device may determine that the end of the burst is detected.

At step 803, the burst duration and inter-burst times may be quantized. Since capturing and storing the distribution of the burst durations and the inter-burst times are of interest, the burst durations and inter-burst times may be quantized to maintain the memory overhead low. One example of the quantization level may include burst duration granularity at 1s, and inter-burst time granularity also at 1s.

At step 804, the device may update the counters for the quantized burst durations and quantized inter-burst times. When a specific burst-duration or inter-burst time is observed, the counter may be incremented. Table 1 below shows an example state of the burst duration and inter-burst time counters. The quantized burst duration of 1, 3 and 2 may be observed 2 times, 2 times and 1 time, respectively. The inter-burst time of 7, 4, and 11 may be observed 3 times, 1 time, and 2 times, respectively. Note that the values that are not observed may not be stored. Alternatively, there may be a higher granularity, e.g., burst duration quantized at 0.2 seconds, and inter-burst time quantized at 0.5 seconds. The higher the granularity, the more accurate a representation of the distribution may be. As a consequence, an accurate prediction of the power consumption may be made. More memory may be needed for a higher granularity.

TABLE 1
Example state of Burst duration and inter-burst time counter

| Burst-length Duration | Counter | Inter-burst Time | Counter |
|---|---|---|---|
| 1 | 2 | 7 | 3 |
| 3 | 3 | 4 | 1 |
| 2 | 1 | 11 | 2 |

At step 805, the device may determine whether the collected statistics are representative. For this specific solution, the representative statistics may be in terms of the total time. For example, when the cumulative inter-burst times and the cumulative burst-durations exceed a threshold, e.g., 5 minutes, the device may determine that sufficient statistics is collected. Alternatively, the representativeness may be defined in terms of the total number of bursts that are observed, e.g., 20 bursts. If statistics are not representative, more data may be collected.

At step 806, if statistics are representative, the device may calculate the expected power consumption. To calculate the expected power, the device power model 812 may be utilized. The device power model 812 may be given in terms of the average current consumption in various states. Specifically, the states may include data transfer, RRC tail, RRC idle, and transitioning between IDLE and CONNECTED states. These currents may be called curr_data, curr_tail, curr_idle, and curr_trans. In addition, there may be a set of candidate values 811 of the release timers for which the expected power consumption may be calculated. An example set of values may be t_set={0.5,1,1.5,2,3,4,5,6,7,8,9}.

At step 807, the expected power consumption may be also calculated for the baseline value of the timer. The baseline value of the timer may be a value set by the NW. This value may be observed to be 10 s. Note also that it may not be meaningful to have values in t_set that are larger than the release timer used by the NW since the RRC connection may be released at the baseline timer if it is not initiated by the UE.

At step 808, the device may determine whether there is any candidate release timer value from t_set that has an expected power less than the baseline power consumption. In the procedure shown, any power consumption lower than the baseline may imply that the early RRC release solution may save power. In another implementation, savings themselves may be above a threshold for the solution to be used, e.g., >5% current savings compared to the baseline timer. If so, the early RRC release solution may be deemed beneficial. Otherwise, the early RRC release solution may not be deemed beneficial.

At step 809, the device may update the UE optimization LUT. The determination made throughout the mode selection process may be stored in the UE optimization table. In addition, further information, e.g., the value of the optimal release timer (i.e., the timer that provides the minimum power consumption), or even the statistics table may be stored.

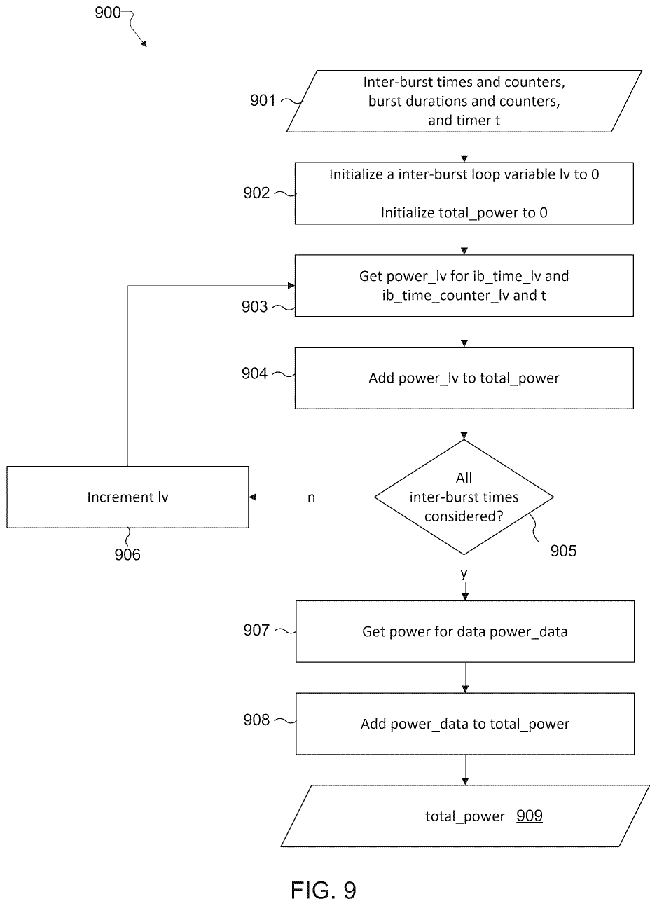

FIG. 9 illustrates an example process 900 of calculating an expected total power in accordance with example embodiments of the present disclosure. The example process as shown in FIG. 9 is for illustration only, and then the process could have the same or similar configuration. One or more of the components illustrated in FIG. 9 may be implemented in specialized circuitry configured to perform the noted functions or one or more of the components may be implemented by one or more processors executing instructions to perform the noted functions. Other embodiments of the expected total power calculation process in accordance with the present disclosure could be used without departing from the scope of this disclosure. FIG. 9 does not limit the scope of this disclosure to any particular embodiment of the expected total power calculation processes.

The example process 900 shown in FIG. 9 may begin at step 901. At step 901, the device may utilize the inter-burst times and their corresponding counters as well as the burst durations and their corresponding counters as an input for this process 900. These may include the information shown in Table 1 above. The rows of the table may be indexed. For example, bl_dur_i may show the burst duration in the ith row, and the bl_dur_cntr_i may show the counter of the burst duration in the ith row. The total number of rows may be I. Similarly, ib_time_i may show the inter-burst time in the ith row, and ib_time_cntr_i may show the counter of the inter-burst time in the ith row. In addition, the value of a timer t may be given as the input. This timer may be any of the candidate timers or the baseline timer for which the power is calculated.

At step 902, an inter-burst loop variable lv and total_power may be initialized to 0. A variable total power may be initialized to accumulate the power during the process and a loop variable lv may be initialized to loop through the rows.

At step 903, power_lv based on ib_time_lv, ib_time_counter_lv, and t may be obtained. Specifically, it may be assumed that the current in RRC tail is curr_tail, RRC idle is curr_idle, and transitioning between states is curr_trans. Further, it may be assumed that the time to transition between states is time_trans. Then, the procedure to obtain the total power may be given as shown in Table 2 below.

TABLE 2
The procedure for total_power calculation.

total_power=0
power_data=0
for lv in 0,1,2,...,I−1:{
power_lv = ib_time_counter_lv × [min(ib_time_lv,t) × curr_tail +
max(0,ib_time_lv−t) × curr_idle +
Ind(t<ib_time_lv) × curr_trans × time_trans].
total_power+= power_lv
}
for lv in 0,1,2,...,I−1:{
power_data += bl_dur_lv × bl_dur_cntr_lv × curr_data.
}
total_power+=power_data

The loop variable lv may assume values from 0 to I−1, where I is the number of rows in Table 1. For calculating power_lv, the first term may model the tail part. If ib_time_lv is lower than t, then the device may remain in tail for ib_time_lv. Otherwise, the device may remain in tail for t. Thus, the first term may take the lower of the timer t and the inter-burst time to obtain the tail time and multiply the tail time with curr_tail to obtain the contribution of RRC tail. The second term may model the idle part. If the inter-burst time is less than the timer t, then there may be no idle time. Otherwise, the idle time may be the difference of the inter-burst time and the timer t. This time may be multiplied with curr_idle to obtain the contribution of RRC idle. Finally, the third term may model the transition cost. If the timer t is less than inter-burst time, then there may be a transition. Otherwise, there may be no transition. The indicator function Ind( ) may provide 1 as output if the condition is met or 0 if the condition is not met. Each transition cost may be calculated by multiplying curr_trans with time_trans. Next, since there are ib_time_counter_lv times, ib_time_counter_lv may be multiplied to obtain power_lv.

At step 904, power_lv may be added to the total power.

At step 905, the device may determine whether all of the inter-burst times have been considered. If not, at step 906 the inter-burst loop variable lv may be incremented. If yes, at step 907, after obtaining power for all the inter-burst times, the power for the data part may be obtained. If the current consumption during data part is curr_data, then the power for the data part may be calculated as shown in Table 2. As such, all duration of the data may be accumulated (by multiplying each duration by its counter and summing over all durations) and multiplied by curr_data to obtain the power consumption of the data part.

At step 908, power_data may be added to total_power to obtain the power 909 that is the desired output of the procedure.

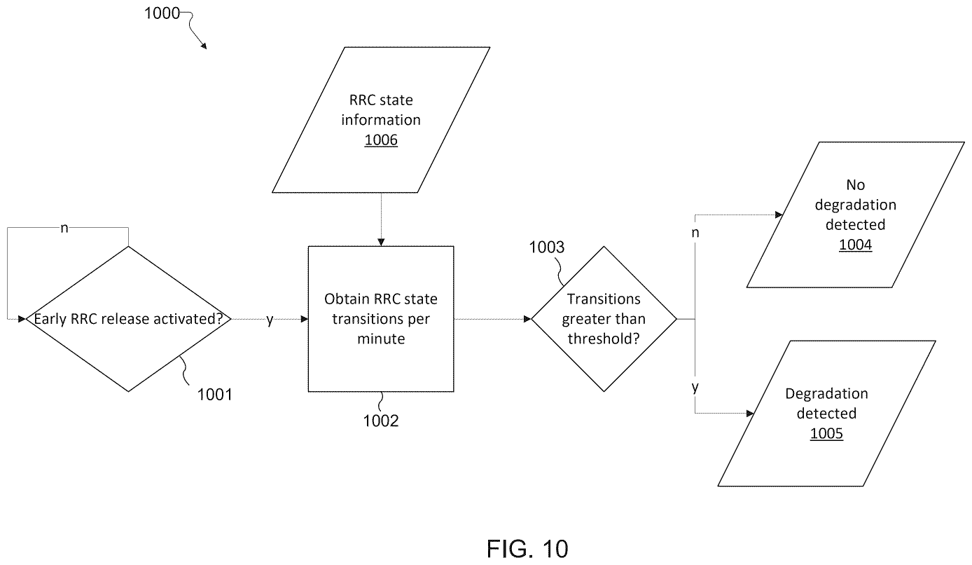

FIG. 10 illustrates an example process 1000 for monitoring for degradation in accordance with example embodiments of the present disclosure. The example mechanism as shown in FIG. 10 is for illustration only, and the mechanism could have the same or similar configuration. One or more of the components illustrated in FIG. 10 may be implemented in specialized circuitry configured to perform the noted functions or one or more of the components may be implemented by one or more processors executing instructions to perform the noted functions. Other embodiments of the degradation monitoring process in accordance with the present disclosure could be used without departing from the scope of this disclosure. FIG. 10 does not limit the scope of this disclosure to any particular embodiment of the degradation monitoring processes.

Once the early RRC release solution is applied, there may be some changes in the statistics of the data that may create a degradation in the performance of the overall solution. If a degradation is detected, then the UE may turn off the early RRC release solution, in which case the NW default RRC release timer may dictate the transition from the RRC connected state to the RRC idle state. In the early RRC release solution, two types of deviations from the optimal behavior may be possible. One type may include the device releasing from the RRC connection later than possible. In this case, the suboptimality may come from remaining in the RRC tail where the device could have switched to the RRC idle state. This behavior may incur some power cost at the UE which can be avoided. Otherwise, it may not impact the operation, and hence can be considered relatively benign. The other possibility may include the device releasing the RRC connection earlier than the optimal time. In this situation, it may transition to the RRC connected state when there are data for the device. As such, the earlier release of the RRC connection may result in frequent transitions, which may incur not only the transition power cost for the UE, but also signaling cost for the NW. Thus, this behavior is to be minimized. The example process 1000 may provide one way to minimize this behavior.

As shown in FIG. 10, the process 1000 may begin at step 1001. At step 1001, the device may determine whether the early RRC release solution is enabled. If so, at step 1002, the number of RRC state transitions that the UE is experiencing during a predefined period (e.g., a minute) may be obtained based on the RRC state information 1006 of the UE.

At step 1003, the device may determine whether the number of the RRC state transitions is greater than a threshold. The threshold may be a static value of an acceptable number of transitions per minute, e.g., 10 transitions per minute. The threshold may also be based on the number of transitions that were seen during the statistics collection. Setting the threshold based on the number of transitions experienced during the statistics collection may enable a solution in which the allowable transitions are relative to the baseline behavior. For example, there may be no more transitions than the baseline behavior, 10% additional transitions as compared to the baseline, and so forth. If the transitions are greater than a chosen threshold, then there may be some degradation 1005 by applying the solution. Otherwise, there may be no degradation 1004.

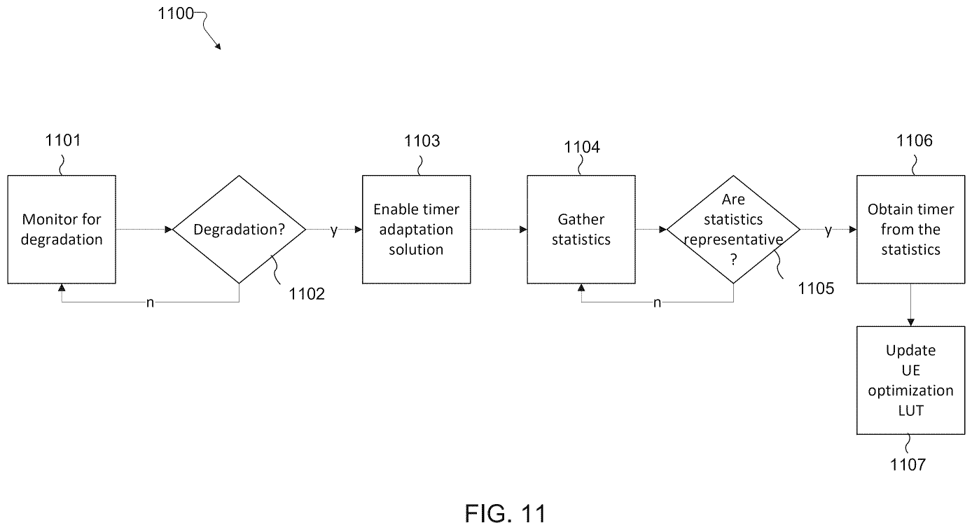

FIG. 11 illustrates an example process 1100 of activating a timer adaptation in accordance with example embodiments of the present disclosure. The example process shown in FIG. 11 is for illustration only, and the process could have the same or similar configuration. One or more of the components illustrated in FIG. 11 may be implemented in specialized circuitry configured to perform the noted functions or one or more of the components may be implemented by one or more processors executing instructions to perform the noted functions. Other embodiments of the timer adaptation activation process in accordance with the present disclosure could be used without departing from the scope of this disclosure. FIG. 11 does not limit the scope of this disclosure to any particular embodiment of the timer adaptation activation processes.

The example process 1100 shown in FIG. 11 may begin at step 1101. At step 1101, the UE may monitor for degradation. At step 1102, the device may determine whether a degradation is detected. At step 1103, a timer adaptation solution may be activated upon detection of a degradation. This may be in contrast to deactivating the early RRC release solution upon detection of degradation and reverting to default mode/parameters. Specifically, once the degradation is detected and while the statistics are being re-collected, the early RRC solution may not be deactivated, and instead a timer adaptation solution may be activated.

At step 1104, statistics may be gathered. The adaptive timer selection methods may consider the most recent traffic from a specific time window, e.g., 30 seconds, and determine a near optimal timer. The adaptive timer selection methods may adapt to variations in the traffic characteristics, but their view may be limited to some timeframe, e.g., 30 seconds in the past. Thus, they may not have the complete long-term picture of the traffic characteristics. Hence, after enabling the adaptive timer solution, the statistics may be gathered.

At step 1105, the device may determine whether the gathered statistics are representative. At step 1106, a timer may be obtained from the gathered statistics. At step 1107, the UE optimization LUT may be updated. As such, when representative statistics are gathered, the UE optimization LUT may be updated based on the timer obtained from the statistics. Subsequently, the early RRC release solution may be run with the obtained timer.

For the early RRC release, the statistics collection may not be impacted by having the early RRC release solution in place. As such, in yet another implementation, once the degradation is detected and the transitions are not too high as compared to a threshold, the early RRC release solution may operate as the statistics are re-collected. When sufficient statistics are gathered, the optimal timer value may be updated. If, however, the transitions are too high such that even transient impact is not tolerable, then the solution may be deactivated.

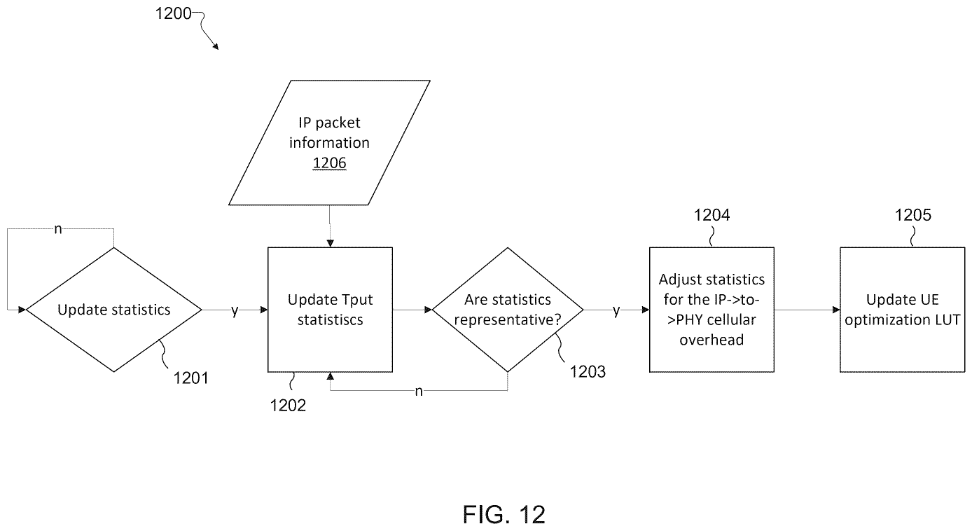

FIG. 12 illustrates an example process 1200 of collecting throughput statistics for MIMO/BW optimization in accordance with example embodiments of the present disclosure. The example process shown in FIG. 12 is for illustration only, and the technique could have the same or similar configuration. One or more of the components illustrated in FIG. 12 may be implemented in specialized circuitry configured to perform the noted functions or one or more of the components may be implemented by one or more processors executing instructions to perform the noted functions. Other embodiments of the collecting throughput statistics process in accordance with the present disclosure could be used without departing from the scope of this disclosure. FIG. 12 does not limit the scope of this disclosure to any particular embodiment of the collecting throughput statistics processes.

The end goal for the statistics may be to provide an estimate of the throughput requests of the application. The MIMO/BW adaptation solution may be developed independently for the UL and DL. To this end, the mean and standard deviation may be collected, and subsequently mean+n×std can be used as estimate of throughput requests, where n could be 1, 2, etc. Alternatively, a percentile can be collected directly as an estimate of the throughput requests, e.g., 90^{th} percentile or 95^{th} percentile. To calculate percentiles without storing all the data, streaming quantile estimation techniques, e.g., P² algorithm may be used.

The example process 1200 shown in FIG. 12 may begin at step 1201. At step 1201, the device may determine whether statistics are to be updated. At step 1202, the throughput statistics may be updated. In the implementation shown in FIG. 12, IP packet information 1206 of all IP packets may be used for statistics collection. Alternatively, IP packet information 1206 of the only relevant IP packets may be collected.

At step 1203, the device may determine whether the throughput statistics are representative. At step 1204, the statistics may be adjusted. For example, the IP packet-based throughput may be converted to a PHY based throughput by considering the overhead of different layers, e.g., packet data convergence protocol (PDCP) layer, radio link control (RLC), medium access control (MAC) layer and IP layer. This overhead may be compensated for in the statistics. An example value for this overhead may be 10-20% for larger packets. In an alternative implementation, the throughput statistics directly from lower layers, e.g., PDCP, RLC, MAC, or PHY layer may be collected. This approach may not permit segregation of the traffic into relevant and non-relevant traffic. Further, for throughput obtained from any layer other than the PHY layer, some conversion to the PHY layer may still be made. At step 1205, the statistics may be used to update the UE optimization LUT.

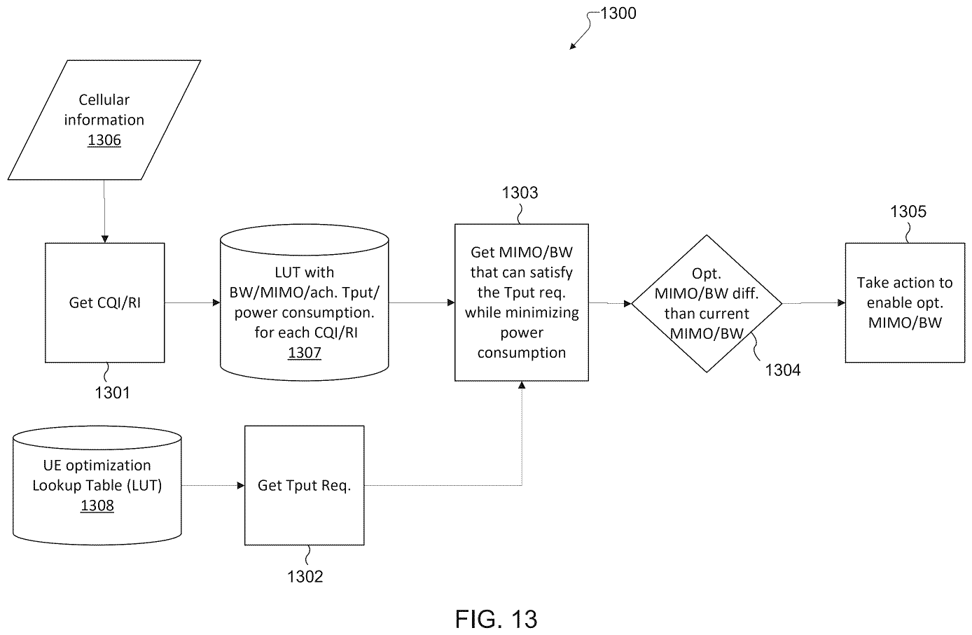

FIG. 13 illustrates an example process 1300 for selecting a MIMO/BW mode in accordance with example embodiments of the present disclosure. The example process shown in FIG. 13 is for illustration only, and the technique could have the same or similar configuration. One or more of the components illustrated in FIG. 13 may be implemented in specialized circuitry configured to perform the noted functions or one or more of the components may be implemented by one or more processors executing instructions to perform the noted functions. Other embodiments of the MIMO/BW mode selection process in accordance with the present disclosure could be used without departing from the scope of this disclosure. FIG. 13 does not limit the scope of this disclosure to any particular embodiment of the MIMO/BW mode selection processes.

The example process 1300 shown in FIG. 13 may begin at step 1301. At step 1301, the device may obtain current channel quality indicator (CQI) and rank indicator (RI) from the cellular information 1306. This information may be utilized to search through an LUT 1307 that may include different MIMO configurations, BW configurations, achievable throughput with those configurations, and power requests of those configurations. This LUT 1307 may be constructed by formulas that relate the 5G NR throughput to the CQI/RI/BW. One example implementation may be based on the below formula:

$$Tput = L \times Q \times R \times Nprb \times 12 / Ts \times ( 1 - OH )$$

Here, L is the number of layers. The layers allocation may be assumed to be highly correlated with the RI. Q and R are the modulation order and the code rate, respectively. 3GPP documents may provide tables relating the modulation order and code rate to the CQI. The Nprb is the number of physical resource blocks and may be obtained from the bandwidth and the subcarrier spacing. Ts is the OFDM symbols period and may be obtained from the subcarrier spacing. OH is the overhead, and may vary depending on the frequency band, e.g., sub-6 GHz or mmWave. Its values may be 14% for FR1 DL, 18% for FR2 DL, 8% for FR1 UL, and 10% for FR2 UL. The power consumption may also come from available studies that provide the scaling of the power with MIMO and BW or may be based on a dedicated study to obtain the power model of a device.

At step 1302, the device may obtain a throughput requests from the UE optimization LUT 1308.

At step 1303, based on the throughput requests from the UE optimization LUT 1308, the device may select an optimal MIMO/BW configuration (that satisfies the throughput requests while minimizing power consumption) from the LUT 1307. Among the configurations that can satisfy the throughput requests, the MIMO/BW configuration that has the least power consumption may be selected as the optimal MIMO/BW configuration.

At step 1304, the device may determine whether the optimal MIMO/BW configuration is different from the current MIMO/BW configuration. At step 1305, if the current MIMO/BW configuration is different from the optimal MIMO/BW configuration, an action may be taken to enable the determined optimal MIMO/BW configuration. This action may include transmitting to the NW a UAI message requesting the change of MIMO/BW configuration.

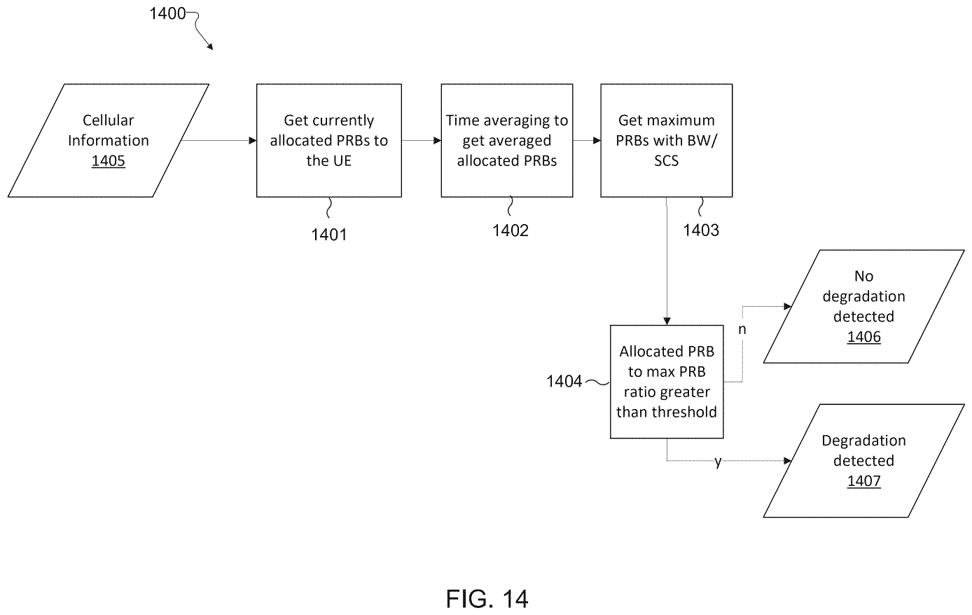

FIG. 14 illustrates an example process 1400 of detecting a degradation for a MIMO/BW mode in accordance with example embodiments of the present disclosure. The example process shown in FIG. 14 is for illustration only, and the process could have the same or similar configuration. One or more of the components illustrated in FIG. 14 may be implemented in specialized circuitry configured to perform the noted functions or one or more of the components may be implemented by one or more processors executing instructions to perform the noted functions. Other embodiments of the degradation detection process for the MIMO/BW optimization in accordance with the present disclosure could be used without departing from the scope of this disclosure. FIG. 14 does not limit the scope of this disclosure to any particular embodiment of the degradation detection processes for the MIMO/BW optimization.

The degradation in the MIMO/BW optimization may be detected by analyzing the available resources and the resources being utilized. FIG. 14 illustrates one example of such implementation. The example process 1400 shown in FIG. 14 may begin at step 1401. At step 1401, the device may obtain the currently allocated PRBs to the UE from the cellular information 1405. At step 1402, the device may obtain average allocated PRBs via time averaging.

The idea behind this implementation may be that if the PRBs allocated to the user exceed a certain percentage, then the user may be under-configured and a degradation in the user experience may be possible. Specifically, the UE may receive the currently allocated PRBs, and time averaged allocation over some time window, e.g., 3 seconds. The time averaged allocation may be obtained separately for the UL and DL. That is, UL time averaged allocation may be obtained from the UL slots and symbols, and DL time averaged allocation may be obtained from the DL slots and symbols.

At step 1403, the device may determine the maximum available PRBs with the configured BW and subcarrier spacing (SCS).

At step 1404, the device may determine that the ratio of the allocated PRBs to the maximum PRBs is greater than a threshold. If the ratio of the allocated PRBs to the available PRBs is greater than a threshold, that may indicate that the UE might be under-configured and at risk for possible service degradation. If the ratio is not greater than a threshold, that may indicate that no degradation is detected 1406. An example value of the threshold may be 0.8. Note that in cellular systems the allocated MIMO layers may be highly correlated with the RI that the UE reports to the NW. As such, in this implementation, it may be assumed that the maximum MIMO layers available for the current channel are being used. Once degradation is detected 1407, the device may initiate a procedure to revert to the default NW configuration of the MIMO/BW.

In another implementation, the UL MAC buffer may be utilized to determine the degradation in the UL. Specifically, the time at which the packets are inserted in the MAC buffer and the time packets are transmitted, i.e., the delay may be tracked. If the packet delay increases beyond a given threshold, it may be declared that a degradation is detected in the UL.

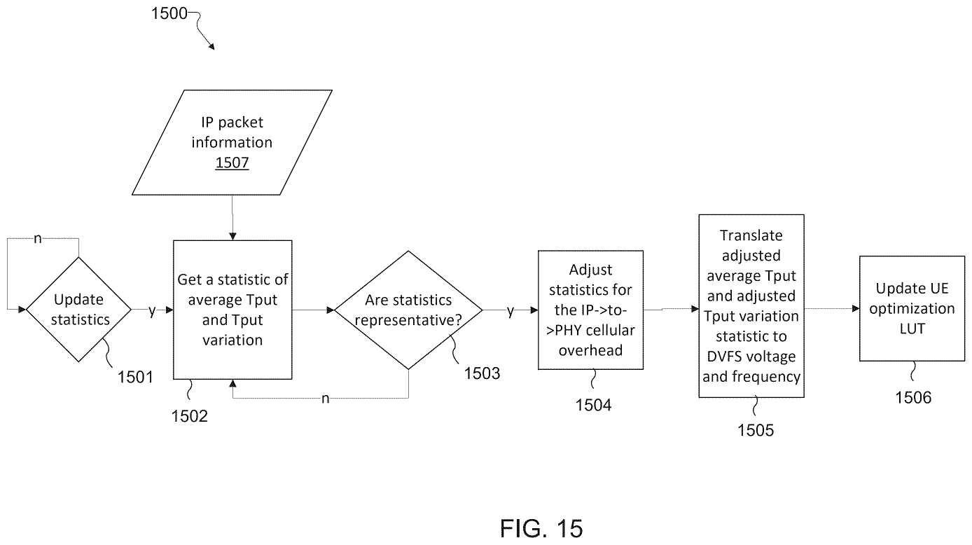

FIG. 15 illustrates an example process 1500 of collecting statistics for a DVFS mode in accordance example embodiments of the present disclosure. The example process and performance shown in FIG. 15 is for illustration only, and the processes could have the same or similar configuration. One or more of the components illustrated in FIG. 15 may be implemented in specialized circuitry configured to perform the noted functions or one or more of the components may be implemented by one or more processors executing instructions to perform the noted functions. Other embodiments of the statistics collection process in accordance with the present disclosure could be used without departing from the scope of this disclosure. FIG. 15 does not limit the scope of this disclosure to any particular embodiment of the statistics collection processes.

For the DVFS optimization, the statistics about the application throughput mean and variation may be collected. A metric for throughput variation may include, e.g., standard deviation, variance, range and/or interquartile range (IQR). The example process 1500 shown in FIG. 15 may begin at step 1501. At step 1501, the device may determine whether statistics are to be updated.

At step 1502, the device may obtain statistics of average throughput and throughput variation from the IP packet information 1507. At step 1503, the device may determine whether the collected statistics are representative.

At step 1504, since the statistics are collected from all packets at the IP layer, the collected statistics may be adjusted from IP to PHY throughput. Alternatively, the statistics may be collected only from relevant packets. The IP packet-based throughput may be converted to PHY based throughput by considering the overhead of different layers, e.g., PDCP layer, RLC, MAC layer and IP layer. This overhead may be compensated for in the statistics. An example value for this overhead may be, e.g., 10-20% for larger packets. In one embodiment, the throughput statistics directly from lower layers, e.g., PDCP, RLC, MAC, or PHY layer may be collected. This approach, however, may not allow segregation of the traffic into relevant and non-relevant traffic. Further, for throughput obtained from any layer other than PHY layer, some conversion to the PHY layer may still be made.

At step 1505, the obtained statistics may be translated to DVFS voltage and frequency. For example, the adjusted average throughput and throughput variation statistics may be translated to the DVFS voltage and frequency. The translation may include determining what voltage and frequency can support the throughput indicated by the statistics. As such, simulation/emulation or on device experiments may be utilized to obtain this translation.

At step 1506, the device may update the UE optimization LUT with the DVFS voltage and frequency.

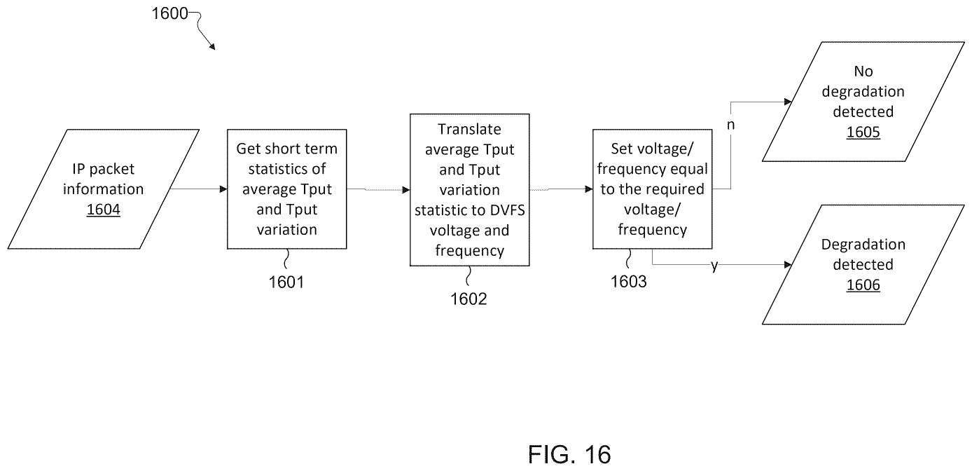

FIG. 16 illustrates an example process 1600 of detecting degradation during a DVFS optimization in accordance with example embodiments of the present disclosure. The example process shown in FIG. 16 is for illustration only, and the process could have the same or similar configuration. One or more of the components illustrated in FIG. 16 may be implemented in specialized circuitry configured to perform the noted functions or one or more of the components may be implemented by one or more processors executing instructions to perform the noted functions. Other embodiments of the degradation detection process in accordance with the present disclosure could be used without departing from the scope of this disclosure. FIG. 16 does not limit the scope of this disclosure to any particular embodiment of degradation detection processes.

Enabling the DVFS optimization solution may imply utilizing the determined DVFS voltage and frequency. For detecting the degradation, short term statistics may be collected and translated to the DVFS voltage and frequency.

The example process 1600 shown in FIG. 16 may begin at step 1601. At step 1601, the device may obtain statistics of average throughput and throughput variation from the IP packet information 1604. At step 1602, the collected statistics may be translated to the DVFS voltage frequency. For example, the average throughput and throughput and throughput variation statistics may be translated to the DVFS voltage and frequency.

At step 1603, the device may determine whether the DVFS voltage and frequency is identical to the set voltage and frequency. If the DVFS frequency and voltage is equal to the set voltage and frequency, this may imply that the device may be operating at the maximum load. At maximum load, it may not be possible to determine whether a higher voltage and frequency may result in an increased throughput or whether this may be indeed the maximum throughput requests of the application at the moment. Thus, it may be declared that degradation is detected 1606. In this example, a single detection degradation may be declared. In an alternative implementation, the device may determine a ratio at which the DVFS voltage and frequency is equal to the set value of voltage and frequency over a predefined period of time. If the ratio exceeds a threshold, it may be declared that degradation is detected 1606. The predefined period may be on the order of a few seconds, e.g., 2 or 3 s, and the ratio may be 0.3.

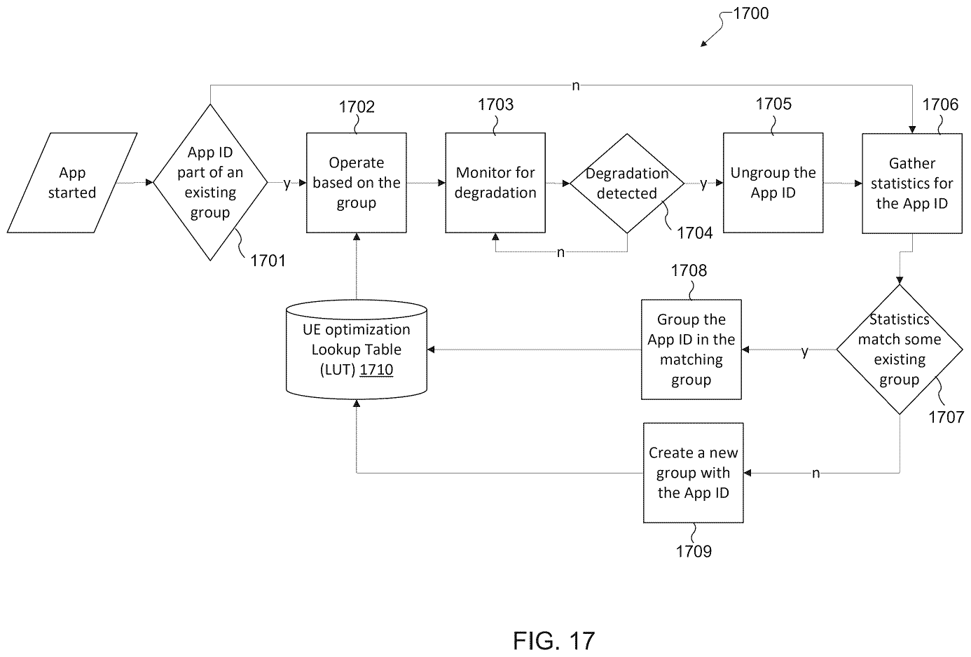

FIG. 17 illustrates an example process 1700 of grouping and ungrouping of an application according to embodiments of the present disclosure. The example process shown in FIG. 17 is for illustration only, and the process could have the same or similar configuration. One or more of the components illustrated in FIG. 17 may be implemented in specialized circuitry configured to perform the noted functions or one or more of the components may be implemented by one or more processors executing instructions to perform the noted functions. Other embodiments of the application grouping and ungrouping process in accordance with the present disclosure could be used without departing from the scope of this disclosure. FIG. 17 does not limit the scope of this disclosure to any particular embodiment of the application grouping and ungrouping processes.

Grouping and ungrouping of an application may be considered when the trigger event type is an application from a group of applications as shown in FIG. 17. For example, if the trigger event is one application from a group of applications and some degradation is detected, then the statistics may not need to be collected for the whole group. Instead, the application for which the degradation is detected may be removed from the group, and statistics may be re-collected. If re-collected statistics match some statistics of the group, then the application may be re-grouped with other applications. The matching may depend on the statistics collected. For example, if the collected statistics are mean and standard deviation or other percentiles, the thresholds may be defined and the statistics are assumed to be matched if they are within those thresholds. For the burst detection based on burst statistics, one possible implementation may be based on the final timer. That is, if the optimal timer is identical to a group, the application ID may be added in that group.

The example process 1700 shown in FIG. 17 may begin at step 1701. At step 1701, the device may determine whether an application as a trigger event is part of an existing group of applications based on the application ID. A group may refer to a collection of one or more applications that share the statistics and the optimal model and parameters.

At step 1702, if application is part of an existing group, the device may operate based on the optimal mode and parameter of that group. At step 1703, the device may monitor for degradation. At step 1704, the device may determine whether a degradation is detected. At step 1705, if degradation is detected, the application ID may be ungrouped from the group. At step 1706, the statistics of the application may be gathered. At step 1707, the device may determine whether the gathered statistics match statistics of an existing group of applications. At step 1708, if the gathered statistics match statistics of an existing group, the application may be regrouped in the existing group with matching statistics. At step 1709, if the gathered statistics do not match statistics of an existing group, a new group may be created with only the application ID. The UE optimization LUT 1710 may be updated and the device may operate with the optimal mode and parameter of the determined group.

If the application is not part of an existing group, statistics may be collected for the application at step 1706. If the statistics match statistics of an existing group at step 1707, then the application may be added to that group at step 1708. Otherwise, a new group may be created at step 1709. The UE optimization LUT may be updated, and the device may operate with the optimal mode and parameters of the determined group.

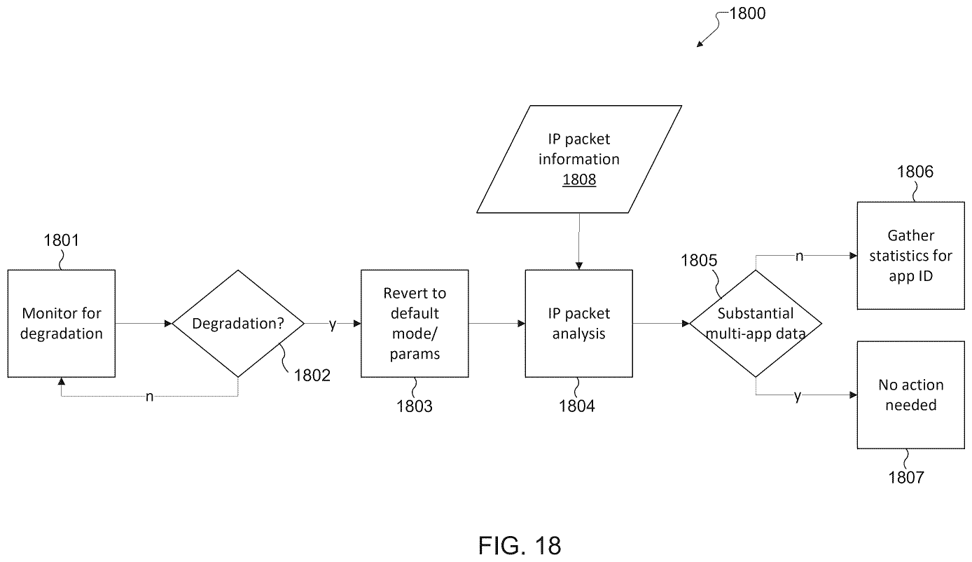

FIG. 18 illustrates an example process 1800 of multi-application degradation and statistics recollection in accordance with example embodiments of the present disclosure. The example process shown in FIG. 18 is for illustration only, and the technique could have the same or similar configuration. One or more of the components illustrated in FIG. 18 may be implemented in specialized circuitry configured to perform the noted functions or one or more of the components may be implemented by one or more processors executing instructions to perform the noted functions. Other embodiments of the multi-application degradation and statistics recollection process in accordance with the present disclosure could be used without departing from the scope of this disclosure. FIG. 18 does not limit the scope of this disclosure to any particular embodiment of the multi-application degradation and statistics recollection processes.

If the statistics of the current traffic do not match the statistics of the traffic when the data was collected, a degradation may occur. One source of this mismatch may be the multi-application traffic. An example for the early RRC release may be background data from applications like TikTok® and Instagram® that can make the device return to the connected state, often resulting in a degradation. For a MIMO/BW optimization, a file download in parallel with the foreground video call may result in a degradation. This kind of degradation may be detected when the data is gathered with all IP packets. For example, during the data collection, there may be little to no background activity, but while using the optimal mode and/or parameters, there may be a large background activity. It may be, however, likely when the statistics information is gathered only from the relevant IP packets. In this situation, if the degradation is detected due to the multi-application traffic, the statistics of the application of interest, i.e., the main foreground application may still be valid. The example process 1800 may provide an example solution for this degradation.

The example process 1800 shown in FIG. 18 may begin at step 1801. At step 1801, the device may monitor for degradation. At step 1802, the device may determine whether a degradation is detected. At step 1803, if a degradation is detected, the device may revert to a default mode and parameters.

At step 1804, the IP packet information 1808 may be analyzed. At step 1805, the device may determine whether there is a substantial multi-app data. What constitutes as substantial may be dependent on the optimal mode. As an example, for the early RRC release, while the amount of data may not be high, semi periodic packets that can make the device transition back to the connected state can be substantial. In the case of a file download, it may last for a relatively short period, e.g., a few seconds to a few minutes, but it may represent a substantial fraction of the total data being consumed at the time. At step 1806, if there is no substantial multi-app data, statistics for the application ID may be gathered. That is, if there is no substantial multi-app data, then it may be likely that the degradation is such that the statistics corresponding to the application ID are to be re-collected. At step 1807, if there is a substantial multi-app data, no action may be performed. For example, if there is a substantial multi-app data, the device may determine whether there may be a degradation without the multi-app data. As such, the statistics may not be re-collected at the moment, but the operation may continue with the default mode and parameters.

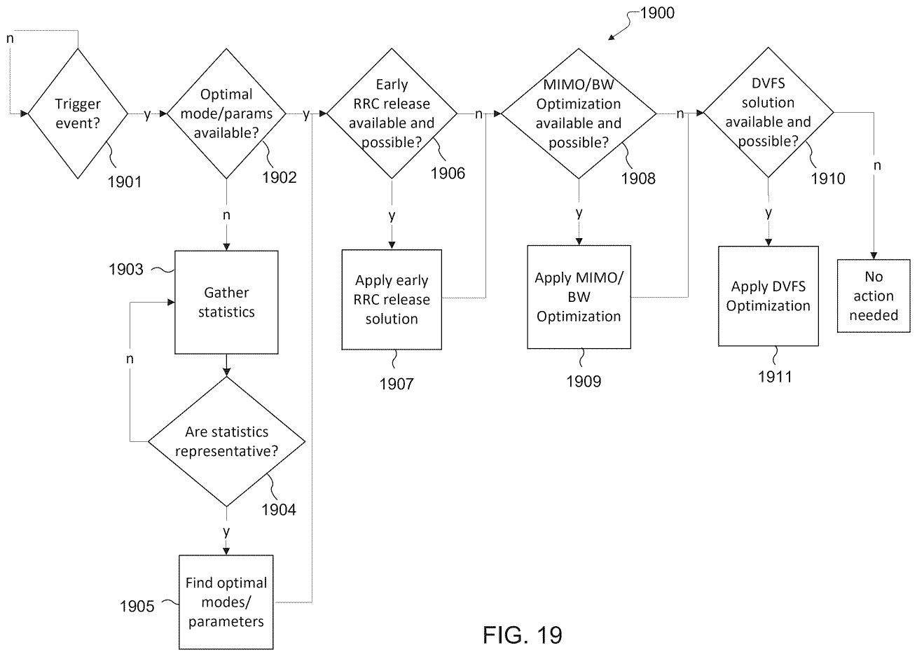

FIG. 19 illustrates an example process 1900 of multi-solution approach in accordance with example embodiments of the present disclosure. The example process shown in FIG. 19 is for illustration only, and the process could have the same or similar configuration. One or more of the components illustrated in FIG. 19 may be implemented in specialized circuitry configured to perform the noted functions or one or more of the components may be implemented by one or more processors executing instructions to perform the noted functions. Other embodiments of the multi-solution approach in accordance with the present disclosure could be used without departing from the scope of this disclosure. FIG. 19 does not limit the scope of this disclosure to any particular embodiment of the multi-solution approaches.

Multiple solutions can be applicable for a single application or a group of applications, e.g., adapting the MIMO/BW optimization as well as the DVFS optimization based on the throughput. Also, it may be possible for an application to be bursty as well as utilizing a low throughput, e.g., email clients or messaging services, which might allow enabling the early RRC release solution, MIMO/BW optimization, and DVFS optimization. If multiple solutions are applicable, the availability or preference may dictate which solution may be utilized. As an example, if the MIMO/BW optimization is enabled by the UAI framework, and either the NW or the UE vendor does not implement the UAI feature, then the DVFS optimization may be implemented. In case both implementations are possible, the priority between the DVFS and MIMO/BW optimization may be based on the fact that the DVFS optimization may be a unilateral solution for the UE, whereas the UAI may utilize signaling to the NW and be based on the NW discretion. In addition, it may be possible to implement both the MIMO/BW optimization and the DVFS optimization. The example process 1900 illustrates one such implementation.

The example process 1900 shown in FIG. 19 may begin at step 1901. At step 1901, the device (e.g., the UE) may determine if a trigger event has occurred. At step 1902, if a trigger event has occurred, the device may determine whether there are optimal modes and/or parameters available for the trigger event. At step 1903, if the optimal modes and/or parameters are not available, statistics may be gathered. At step 1904, the device may determine whether the statistics are representative. The statistics collection may continue until the collected statistics are representative. At step 1905, if the statistics are representative, the optimal modes and parameters may be identified.

At step 1906, the device may determine whether the early RRC release solution is available and possible based on the identified optimal modes and parameters. Availability here may mean that the early RRC release solution may be beneficial for the trigger event, whereas possibility here may mean that it may be possible to currently utilize the early RRC release solution. As discussed above, the early RRC release may be enabled by the UAI, and even though it may be beneficial for the application and supported by the UE, the early RRC release may not be available in the NW in which the UE is currently operating. At step 1907, if the early RRC release solution is available and possible, the early RRC release may be enabled.

At step 1908, the device may determine whether the MIMO/BW optimization is available and possible. Possibility for the MIMO/BW optimization may be dictated by whether the UAI feature is implemented by the NW. At step 1909, if the MIMO/BW optimization is available and possible, the MIMO/BW optimization may be enabled. Thus, the MIMO/BW optimization may be applied alone or simultaneously with the early RRC release if both solutions were determined to be available and possible.

At step 1910, the device may determine whether the DVFS optimization is available and possible. At step 1911, if the DVFS optimization is available and possible, the DVFS optimization may be enabled. Thus, the DVFS optimization may be applied alone or simultaneously with one or more of the early RRC release and the MIMO/BW optimization. If none of the early RRC release, MIMO/BW optimization or DVFS optimization is available and possible, no action may be performed.

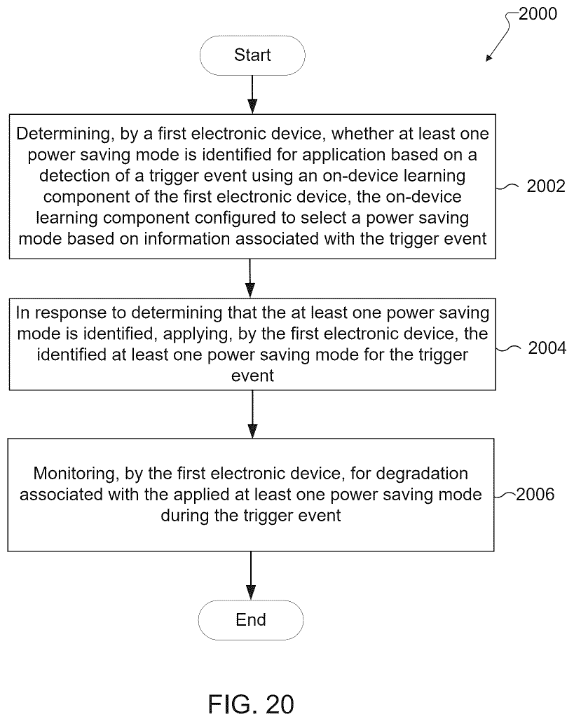

FIG. 20 illustrates a flow chart of the on-device learning based power saving method 2000 in accordance with example embodiments of the present disclosure. The embodiment of the on-device learning based power saving method in FIG. 20 is for illustration only. Other embodiments of the on-device learning based power saving method may be used without departing from the scope of this disclosure. In the example of FIG. 20, the on-device learning based power saving method 2000 may be performed by a first electronic device (such as a UE 111-116 of FIGS. 1 and 3).

In the example of FIG. 20, the method 2000 may begin at step 2002. At step 2002, the first electronic device may determine whether at least one power saving mode is identified for application based on a detection of a trigger event using an on-device learning component of the first electronic device, the on-device learning component configured to select a power saving mode based on information associated with the trigger event. This may include determining whether the identified at least one power saving mode is different from a current power saving mode. In response to a determination that the identified at least one power saving mode is different from the current power saving mode, the first electronics device may switch from the current power saving mode to the identified at least one power saving mode. In response to a determination that the identified at least one power saving mode is the current power saving mode, the first electronic device may also determine whether parameters of the current power saving mode are to be changed based on the information associated with the trigger event. In response to a determination that the parameter of the current power saving mode are to be changed, the first electronic device may change the parameters and apply the current power saving mode with the changed parameters. In response to a determination that the parameters of the current power saving modes are not to be changed, the first electronic device may apply the current power saving mode with the parameters.

In one embodiment, the first electronic device may determine whether the at least one power saving mode is identified by determining whether the identified at least one power saving mode includes an RRC release. The first electronic device may determine whether the identified at least one power saving mode includes an RRC release by gathering packet IAT statistics including mean and standard deviation based on IP packets and determining whether the gathered packet IAT statistics are representative of properties of data associated with the trigger event. In response to a determination that the gathered packet IAT statistics are representative of the properties of the data, the first electronic device may compare a ratio of the mean and standard deviation to a threshold and determine that the identified at least one power saving mode includes the RRC release based on the ratio being greater than the threshold.

In one embodiment, the first electronic device may determine whether the at least one power saving mode is identified by determining whether the identified at least one power saving mode includes an RRC release. This may include the first electronic device gathering packet IAT statistics based on IP packets to identify bursts, burst durations and inter-burst periods, and determining whether the gathered packet IAT statistics are representative of properties of data associated with the trigger event based on a number of the bursts identified. In response to a determination that the gathered packet IAT statistics are representative of the properties of the data, the first electronic device may also estimate a power consumption for the trigger event based on candidate release timer values, a baseline timer value, and average current values during data transfer, RRC tail, RRC idle, and transitioning states, and determine that the identified at least one power saving mode includes the RRC release based on an estimated power consumption with each candidate release timer value being less than an estimated power consumption with the baseline timer value.

In one embodiment, the first electronic device may determine whether the at least one power saving mode is identified by determining whether the identified at least one power saving mode includes a MIMO and/or BW optimization. This may include the first electronic device collecting throughput statistics including mean and standard deviation associated with the trigger event, obtaining current channel information including a CQI and an RI. Further, this may also include the first electronic device determining, based on the throughput statistics and the current channel information, an estimated throughput for the trigger event from an LUT of the on-device learning component (the LUT constructed based on the CQI, RI and BW), and identifying a MIMO and/or BW configuration from the LUT based on the estimated throughput.

In one embodiment, the first electronic device may determine whether the at least one power saving mode is identified by determining whether the identified at least one power saving mode includes a DVFS. This may include the first electronic device collecting throughput statistics including mean and standard deviation to estimate a throughput associated with the trigger event, and identifying DVFS voltage and frequency based on the throughput statistics and the estimated throughput.

At step 2004, the first electronic device may apply the identified at least one power saving mode for the trigger event.

At step 2006, in response to determining that the at least one power saving mode is identified, the first electronic device may monitor for degradation associated with the applied at least one power saving mode during the trigger event. This may include the first electronic device comparing current information associated with the trigger event to collected information stored in an LUT of the on-device learning component, where the current information includes at least one of a number of RRC state transitions over a predefined period, a number of currently allocated PRBs, and throughput statistics over a predefined period translated to DVFS voltage and frequency. Also, this may further include the first electronic device identifying a change in the current information associated with the trigger event and a degradation of the applied at least one power saving mode based on the change, where the change includes at least one of the number of the RRC state transitions greater than a threshold, the number of currently allocated PRBs greater than a threshold, and a current DVFS voltage and frequency equal to a threshold. Further, this may additionally include the first electronic device disabling the applied at least one power saving mode and applying a different power saving mode including at least one of a power saving mode configured by a second electronic device for the first electronic device and an RRC release with an adaptive timer. In addition, this may also include the first electronic device continuously collecting the current information associated with the trigger event, and updating the LUT based on the current information.

In one embodiment, the trigger event may include opening of an application from a first group of applications, and the degradation associated with the applied at least one power saving mode is detected. The first electronic device may ungroup the application from the first group of the applications upon detecting the degradation, recollect statistics for the application, and regroup the application to a second group of applications based on the recollected statistics.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
determining, by a first electronic device, whether at least one power saving mode is identified for application based on a detection of a trigger event using an on-device learning component of the first electronic device, the on-device learning component configured to select a power saving mode based on information associated with the trigger event;
in response to determining that the at least one power saving mode is identified, applying, by the first electronic device, the identified at least one power saving mode for the trigger event; and
monitoring, by the first electronic device, for degradation associated with the applied at least one power saving mode during the trigger event.

2. The method of claim 1, wherein determining whether the at least one power saving mode is identified comprises:
determining whether the identified at least one power saving mode is different from a current power saving mode; and
one of:
in response to a determination that the identified at least one power saving mode is different from the current power saving mode, switching from the current power saving mode to the identified at least one power saving mode;
in response to a determination that the identified at least one power saving mode is the current power saving mode, determining whether parameters of the current power saving mode are to be changed based on the information associated with the trigger event, and in response to a determination that the parameters are to be changed, changing the parameters and applying the current power saving mode with the changed parameters; or
in response to the determination that the identified at least one power saving mode is the current power saving mode and a determination that the parameters of the current power saving modes are not to be changed, applying the current power saving mode with the parameters.

3. The method of claim 1, wherein:
determining whether the at least one power saving mode is identified comprises determining whether the identified at least one power saving mode includes a radio resource control (RRC) release; and
determining whether the identified at least one power saving mode includes an RRC release comprises:
gathering packet inter-arrival times (IAT) statistics including mean and standard deviation based on internet protocol (IP) packets;
determining whether the gathered packet IAT statistics are representative of properties of data associated with the trigger event;
in response to a determination that the gathered packet IAT statistics are representative of the properties of the data, comparing a ratio of the mean and standard deviation to a threshold; and
determining that the identified at least one power saving mode includes the RRC release based on the ratio being greater than the threshold.

4. The method of claim 1, wherein:
determining whether the at least one power saving mode is identified comprises determining whether the identified at least one power saving mode includes a radio resource control (RRC) release; and
determining whether the identified at least one power saving mode includes an RRC release comprises:
gathering packet inter-arrival times (IAT) statistics based on internet protocol (IP) packets to identify bursts, burst durations and inter-burst periods;
determining whether the gathered packet IAT statistics are representative of properties of data associated with the trigger event based on a number of the bursts identified;
in response to a determination that the gathered packet IAT statistics are representative of the properties of the data, estimating a power consumption for the trigger event based on candidate release timer values, a baseline timer value, and average current values during data transfer, RRC tail, RRC idle, and transitioning states; and
determining that the identified at least one power saving mode includes the RRC release based on an estimated power consumption with each candidate release timer value being less than an estimated power consumption with the baseline timer value.

5. The method of claim 1, wherein:
determining whether the at least one power saving mode is identified comprises determining whether the identified at least one power saving mode includes a multiple-input multiple-output (MIMO) and/or bandwidth (BW) optimization; and
determining whether the identified at least one power saving mode includes a MIMO and/or BW optimization comprises:
collecting throughput statistics including mean and standard deviation associated with the trigger event;
obtaining current channel information including a channel quality indicator (CQI) and a rank indicator (RI);
determining, based on the throughput statistics and the current channel information, an estimated throughput for the trigger event from a lookup table (LUT) of the on-device learning component, the LUT constructed based on the CQI, RI and BW; and
identifying a MIMO and/or BW configuration from the LUT based on the estimated throughput.

6. The method of claim 1, wherein:
determining whether the at least one power saving mode is identified comprises determining whether the identified at least one power saving mode includes a dynamic voltage and frequency scaling (DVFS); and
determining whether the identified at least one power saving mode includes a DVFS comprises:
collecting throughput statistics including mean and standard deviation to estimate a throughput associated with the trigger event; and
identifying DVFS voltage and frequency based on the throughput statistics and the estimated throughput.

7. The method of claim 1, wherein monitoring for degradation comprises:
comparing current information associated with the trigger event to collected information stored in a lookup table (LUT) of the on-device learning component, the current information comprising at least one of a number of radio resource control (RRC) state transitions over a predefined period, a number of currently allocated physical resource blocks (PRBs), and throughput statistics over a predefined period translated to dynamic voltage and frequency scaling (DVFS) voltage and frequency;
identifying a change in the current information associated with the trigger event and a degradation of the applied at least one power saving mode based on the change, the change comprising at least one of the number of the RRC state transitions greater than a threshold, the number of currently allocated PRBs greater than a threshold, and a current DVFS voltage and frequency equal to a threshold;
disabling the applied at least one power saving mode and applying a different power saving mode including at least one of a power saving mode configured by a second electronic device for the first electronic device and an RRC release with an adaptive timer;
continuously collecting the current information associated with the trigger event; and
updating the LUT based on the current information.

8. The method of claim 1, wherein:
the trigger event comprises opening of an application from a first group of applications,
the degradation associated with the applied at least one power saving mode is detected, and
the method further comprises:
ungrouping the application from the first group of the applications upon detecting the degradation;
recollecting statistics for the application; and
regrouping the application to a second group of applications based on the recollected statistics.

9. A first electronic device comprising:
memory; and
a processor operably coupled to the memory, the processor configured to:
determine whether at least one power saving mode is identified for application based on a detection of a trigger event using an on-device learning component of the first electronic device, the on-device learning component configured to select a power saving mode based on information associated with the trigger event;
in response to a determination that the at least one power saving mode is identified, apply the identified at least one power saving mode for the trigger event; and
monitor for degradation associated with the applied at least one power saving mode during the trigger event.

10. The first electronics device of claim 9, wherein to determine whether the at least one power saving mode is identified, the processor is further configured to:
determine whether the identified at least one power saving mode is different from a current power saving mode; and
one of:
in response to a determination that the identified at least one power saving mode is different from the current power saving mode, switch from the current power saving mode to the identified at least one power saving mode;
in response to a determination that the identified at least one power saving mode is the current power saving mode, determine whether parameters of the current power saving mode are to be changed based on the information associated with the trigger event, and in response to a determination that the parameters are to be changed, change the parameters and apply the current power saving mode with the changed parameters; or
in response to the determination that the identified at least one power saving mode is the current power saving mode and a determination that the parameters of the current power saving modes are not to be changed, apply the current power saving mode with the parameters.

11. The first electronics device of claim 9, wherein:
to determine whether the at least one power saving mode is identified, the processor is further configured to determine whether the identified at least one power saving mode includes a radio resource control (RRC) release; and
to determine whether the identified at least one power saving mode includes an RRC release, the processor is further configured to:
gather packet inter-arrival times (IAT) statistics including mean and standard deviation based on internet protocol (IP) packets;
determine whether the gathered packet IAT statistics are representative of properties of data associated with the trigger event;
in response to a determination that the gathered packet IAT statistics are representative of the properties of the data, compare a ratio of the mean and standard deviation to a threshold; and
determine that the identified at least one power saving mode includes the RRC release based on the ratio being greater than the threshold.

12. The first electronics device of claim 9, wherein:
to determine whether the at least one power saving mode is identified, the processor is further configured to determine whether the identified at least one power saving mode includes a radio resource control (RRC) release; and
to determine whether the identified at least one power saving mode includes an RRC release, the processor is further configured to:
gather packet inter-arrival times (IAT) statistics based on internet protocol (IP) packets to identify bursts, burst durations and inter-burst periods;
determine whether the gathered packet IAT statistics are representative of properties of data associated with the trigger event based on a number of the bursts identified;
in response to a determination that the gathered packet IAT statistics are representative of the properties of the data, estimate a power consumption for the trigger event based on candidate release timer values, a baseline timer value, and average current values during data transfer, RRC tail, RRC idle, and transitioning states; and
determine that the identified at least one power saving mode includes the RRC release based on an estimated power consumption with each candidate release timer value being less than an estimated power consumption with the baseline timer value.

13. The first electronics device of claim 9, wherein:
to determine whether the at least one power saving mode is identified, the processor is further configured to determine whether the identified at least one power saving mode includes a multiple-input multiple-output (MIMO) and/or bandwidth (BW) optimization; and
to determine whether the identified at least one power saving mode includes a MIMO and/or BW optimization, the processor is further configured to:
collect throughput statistics including mean and standard deviation associated with the trigger event;
obtain current channel information including a channel quality indicator (CQI) and a rank indicator (RI);
determine, based on the throughput statistics and the current channel information, an estimated throughput for the trigger event from a lookup table (LUT) of the on-device learning component, the LUT constructed based on the CQI, RI and BW; and
identify a MIMO and/or BW configuration from the LUT based on the estimated throughput.

14. The first electronics device of claim 9, wherein:
to determine whether the at least one power saving mode is identified, the processor is further configured to determine whether the identified at least one power saving mode includes a dynamic voltage and frequency scaling (DVFS); and
to determine whether the identified at least one power saving mode includes a DVFS, the processor is further configured to:
collect throughput statistics including mean and standard deviation to estimate a throughput associated with the trigger event; and
identify DVFS voltage and frequency based on the throughput statistics and the estimated throughput.

15. The first electronics device of claim 9, wherein to monitor for degradation, the processor is further configured to:
compare current information associated with the trigger event to collected information stored in a lookup table (LUT) of the on-device learning component, the current information comprising at least one of a number of radio resource control (RRC) state transitions over a predefined period, a number of currently allocated physical resource blocks (PRBs), and throughput statistics over a predefined period translated to dynamic voltage and frequency scaling (DVFS) voltage and frequency;
identify a change in the current information associated with the trigger event and a degradation of the applied at least one power saving mode based on the change, the change comprising at least one of the number of the RRC state transitions greater than a threshold, the number of currently allocated PRBs greater than a threshold, and a current DVFS voltage and frequency equal to a threshold;
disable the applied at least one power saving mode and applying a different power saving mode including at least one of a power saving mode configured by a second electronic device for the first electronic device and an RRC release with an adaptive timer;
continuously collect the current information associated with the trigger event; and
update the LUT based on the current information.

16. A non-transitory computer readable medium embodying a computer program, the computer program comprising program code that, when executed by a processor of a first electronic device, causes the first electronic device to:
determine whether at least one power saving mode is identified for application based on a detection of a trigger event using an on-device learning component of the first electronic device, the on-device learning component configured to select a power saving mode based on information associated with the trigger event;
in response to a determination that the at least one power saving mode is identified, apply the identified at least one power saving mode for the trigger event; and
monitor for degradation associated with the applied at least one power saving mode during the trigger event.

17. The non-transitory computer readable medium of claim 16, wherein the program code that, when executed by the processor of the first electronic device, causes the first electronic device to determine whether the at least one power saving mode is identified comprises program code that, when executed by the processor of the first electronic device, causes the first electronic device to:
determine whether the identified at least one power saving mode is different from a current power saving mode; and
one of:
in response to a determination that the identified at least one power saving mode is different from the current power saving mode, switch from the current power saving mode to the identified at least one power saving mode;
in response to a determination that the identified at least one power saving mode is the current power saving mode, determine whether parameters of the current power saving mode are to be changed based on the information associated with the trigger event, and in response to a determination that the parameters are to be changed, change the parameters and apply the current power saving mode with the changed parameters; or
in response to the determination that the identified at least one power saving mode is the current power saving mode and a determination that the parameters of the current power saving modes are not to be changed, apply the current power saving mode with the parameters.

18. The non-transitory computer readable medium of claim 16, wherein:
the program code that, when executed by the processor of the first electronic device, causes the first electronic device to determine whether the at least one power saving mode is identified comprises program code that, when executed by the processor of the first electronic device, causes the first electronic device to determine whether the identified at least one power saving mode includes a radio resource control (RRC) release;
the program code that, when executed by the processor of the first electronic device, causes the first electronic device to determine whether the identified at least one power saving mode includes an RRC release comprises program code that, when executed by the processor of the first electronic device, cause the first electronic device to:
gather packet inter-arrival times (IAT) statistics based on internet protocol (IP) packets to identify bursts, burst durations and inter-burst periods;
determine whether the gathered packet IAT statistics are representative of properties of data associated with the trigger event based on a number of the bursts identified;
in response to a determination that the gathered packet IAT statistics are representative of the properties of the data, estimate a power consumption for the trigger event based on candidate release timer values, a baseline timer value, and average current values during data transfer, RRC tail, RRC idle, and transitioning states; and
determine that the identified at least one power saving mode includes the RRC release based on an estimated power consumption with each candidate release timer value being less than an estimated power consumption with the baseline timer value.

19. The non-transitory computer readable medium of claim 16, wherein:
the program code that, when executed by the processor of the first electronic device, causes the first electronic device to determine whether the at least one power saving mode is identified comprises program code that, when executed by the processor of the first electronic device, causes the first electronic device to determine whether the identified at least one power saving mode includes a multiple-input multiple-output (MIMO) and/or bandwidth (BW) optimization; and
the program code that, when executed by the processor of the first electronic device, causes the first electronic device to determine whether the identified at least one power saving mode includes a MIMO and/or BW optimization comprises program code that, when executed by the processor of the first electronic device, causes the first electronic device to:
collect throughput statistics including mean and standard deviation associated with the trigger event;
obtain current channel information including a channel quality indicator (CQI) and a rank indicator (RI);
determine, based on the throughput statistics and the current channel information, an estimated throughput for the trigger event from a lookup table (LUT) of the on-device learning component, the LUT constructed based on the CQI, RI and BW; and
identify a MIMO and/or BW configuration from the LUT based on the estimated throughput.

20. The non-transitory computer readable medium of claim 16, wherein:
the program code that, when executed by the processor of the first electronic device, causes the first electronic device to determine whether the at least one power saving mode is identified comprises program code that, when executed by the processor of the first electronic device, causes the first electronic device to determine whether the identified at least one power saving mode includes a dynamic voltage and frequency scaling (DVFS); and
the program code that, when executed by the processor of the first electronic device, causes the first electronic device to determine whether the identified at least one power saving mode includes a DVFS comprises program code that, when executed by the processor of the first electronic device, causes the first electronic device to:
collect throughput statistics including mean and standard deviation to estimate a throughput associated with the trigger event; and
identify DVFS voltage and frequency based on the throughput statistics and the estimated throughput.
